(19) United States
(12) Patent Application Publication
(10) Pub. No.: US 2026/0254563 A1
(43) Pub. Date: Aug. 27, 2026

(54) TECHNIQUES FOR INTER-BAND INTERFERENCE MEASUREMENT AND REPORTING

(71) Applicant: QUALCOMM Incorporated, San Diego, CA (US)

(72) Inventors: Qian ZHANG, Basking Ridge, NJ (US); Tao LUO, San Diego, CA (US); Navid ABEDINI, Basking Ridge, NJ (US); Junyi LI, Greentown, PA (US); Igor GUTMAN, Hod HaSharon (IL); Mostafa KHOSHNEVISAN, San Diego, CA (US); Xiaoxia ZHANG, San Diego, CA (US); Qing LI, PRINCETON JUNCTION, NJ (US); Sony AKKARAKARAN, Poway, CA (US)

(21) Appl. No.: 19/059,529

(22) Filed: Feb. 21, 2025

(51) Int. Cl. H04L 1/00; H04W 72/1273

(52) U.S. Cl. CPC H04L 1/0071; H04W 72/1273

(57) ABSTRACT

Methods, systems, and devices for wireless communications are described. In some cases, a user equipment (UE) may measure inter-band interference between uplink communications transmitted by the UE and downlink communications received by the UE. In such cases, the inter-band interference may be based on a second frequency band associated with the uplink communications being within a threshold frequency of a first frequency band associated with the downlink communications. For example, the first frequency band may be associated with a first frequency of 3.5 gigahertz and the second frequency band may be associated with a second frequency of 7 gigahertz. As such, the UE may transmit a report indicative of the inter-band interference between uplink communications and downlink communications based on measurement of the inter-band interference. In such cases, the report may include an indication of one or more metrics associated with the inter-band interference.

### FIELD OF TECHNOLOGY

The following relates to wireless communications, including techniques for inter-band interference measurement and reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include measuring inter-band interference between one or more uplink communications transmitted by the UE and one or more downlink communications received by the UE, where the inter-band interference is based on a first frequency of a first frequency band associated with the one or more downlink communications being double a second frequency of a second frequency band associated with the one or more uplink communications, generating one or more metrics associated with the inter-band interference based on the measurement of the inter-band interference, and sending a report that comprises an indication of the one or more metrics associated with the inter-band interference.

A UE for wireless communications is described. The UE may include one or more memories storing processor executable code, and one or more processors coupled with the one or more memories. The one or more processors may individually or collectively be operable to execute the code to cause the UE to measure inter-band interference between one or more uplink communications transmitted by the UE and one or more downlink communications received by the UE, where the inter-band interference is based on a first frequency of a first frequency band associated with the one or more downlink communications being double a second frequency of a second frequency band associated with the one or more uplink communications, generate one or more metrics associated with the inter-band interference based on the measurement of the inter-band interference, and send a report that comprises an indication of the one or more metrics associated with the inter-band interference.

Another UE for wireless communications is described. The UE may include means for measuring inter-band interference between one or more uplink communications transmitted by the UE and one or more downlink communications received by the UE, where the inter-band interference is based on a first frequency of a first frequency band associated with the one or more downlink communications being double a second frequency of a second frequency band associated with the one or more uplink communications, means for generating one or more metrics associated with the inter-band interference based on the measurement of the inter-band interference, and means for sending a report that comprises an indication of the one or more metrics associated with the inter-band interference.

A non-transitory computer-readable medium storing code for wireless communications is described. The code may include instructions executable by one or more processors to measure inter-band interference between one or more uplink communications transmitted by the UE and one or more downlink communications received by the UE, where the inter-band interference is based on a first frequency of a first frequency band associated with the one or more downlink communications being double a second frequency of a second frequency band associated with the one or more uplink communications, generate one or more metrics associated with the inter-band interference based on the measurement of the inter-band interference, and send a report that comprises an indication of the one or more metrics associated with the inter-band interference.

Some examples of the method, UEs, and non-transitory computer-readable medium described herein may further include operations, features, means, or instructions for receiving control signaling indicative of one or more resources to be used for the measurement, in the first frequency band associated with the one or more downlink communications, of the inter-band interference.

In some examples of the method, UEs, and non-transitory computer-readable medium described herein, the one or more resources associated with the measurement of the inter-band interference may be periodic, semi-persistent, or aperiodic.

In some examples of the method, UEs, and non-transitory computer-readable medium described herein, the control signaling indicates one or more resource identifiers associated with the one or more resources associated with an inter-band interference resource set, an index associated with a first resource of the one or more resources, a quantity of the one or more resources, a symbol associated with the first resource of the one or more resources within a slot, a quantity of symbols associated with the one or more resources within the slot, a periodicity and a slot offset associated with the one or more resources, a subcarrier spacing associated with the one or more resources, quasi-co-location (QCL) information, with qcl-Type set to ‘typeD,’ associated with the one or more resources, or any combination thereof.

In some examples of the method, UEs, and non-transitory computer-readable medium described herein, the QCL information includes a list of transmission configuration indicator (TCI) states and the measurement of each of the one or more resources may be in accordance with a TCI state from the list of TCI states.

In some examples of the method, UEs, and non-transitory computer-readable medium described herein, the measurement of the one or more resources may be in accordance with a TCI state associated with one of a last received downlink shared channel prior to the one or more resources and a latest monitored control resource set prior to the one or more resources based on the QCL information not being configured and based on unifiedTCI-StateType not being configured.

In some examples of the method, UEs, and non-transitory computer-readable medium described herein, the measurement of the one or more resources may be in accordance with a TCI state associated with an indicated downlink only TCI state, an indicated joint TCI state, or both, prior to the one or more resources based on the QCL information not being configured and based on unifiedTCI-StateType being configured.

In some examples of the method, UEs, and non-transitory computer-readable medium described herein, the one or more resources may be periodic resources, each resource of the one or more resources may be associated with a respective TCI state configured per resource of the one or more resources in accordance with one or more respective parameters, and the measurement of the one or more resources may be in accordance with the respective TCI states.

In some examples of the method, UEs, and non-transitory computer-readable medium described herein, the control signaling includes an activation or deactivation medium access control-control element (MAC-CE) message, the activation or deactivation MAC-CE message includes one or more fields indictive of one or more TCI states associated with the one or more resources, and the measurement of the one or more resources may be in accordance with the one or more TCI states.

In some examples of the method, UEs, and non-transitory computer-readable medium described herein, the measurement of the inter-band interference may be based on transmission of one or more uplink messages via one or more second resources in the second frequency band associated with the one or more uplink communications, the one or more second resources at least partially overlap the one or more resources, and the one or more uplink messages includes one or more SRSs (SRSs), one or more demodulation reference signals (DMRSs), one or more uplink reference signals, or any combination thereof.

In some examples of the method, UEs, and non-transitory computer-readable medium described herein, the one or more uplink messages may be transmitted in accordance with an uplink transmission power and the uplink transmission power may be a default transmission power, may be based on an indication from a network entity, may be based on a range of uplink transmission powers, or any combination thereof.

In some examples of the method, UEs, and non-transitory computer-readable medium described herein, the control signaling includes a CSI-ResourceConfig information element (IE) and the CSI-ResourceConfig IE may be indicative of an interference measurement resource set list including the one or more resources.

In some examples of the method, UEs, and non-transitory computer-readable medium described herein, the control signaling includes a CSI-ResourceConfig IE and the CSI-ResourceConfig IE includes an indication of an identifier of a resource configuration associated with the one or more resources.

In some examples of the method, UEs, and non-transitory computer-readable medium described herein, the control signaling includes a CSI-IM IE indicative of the one or more resources.

In some examples of the method, UEs, and non-transitory computer-readable medium described herein, the one or more resources include a set of aperiodic resources, the control signaling may be DCI signaling in an aperiodic inter-band interference resource set configuration, and the transmission of the report may be in accordance with a slot offset between a first slot associated with the downlink control information (DCI) signaling that triggers the set of aperiodic resources and a second slot in which the set of aperiodic resources may be measured.

Some examples of the method, UEs, and non-transitory computer-readable medium described herein may further include operations, features, means, or instructions for receiving control signaling indicative of configuration information associated with the report, where the transmission of the report may be based on reception of the control signaling.

In some examples of the method, UEs, and non-transitory computer-readable medium described herein, the control signaling may be indicative of a sub-band size, a quantity of sub-bands, or both and the one or more metrics include one or more respective metrics associated with each sub-band among the quantity of sub-bands.

In some examples of the method, UEs, and non-transitory computer-readable medium described herein, the control signaling indicates that the report may be a wideband report.

In some examples of the method, UEs, and non-transitory computer-readable medium described herein, the report may be aperiodic, periodic, or semi-persistent.

In some examples of the method, UEs, and non-transitory computer-readable medium described herein, the control signaling includes a CSI-reportConfig IE, the CSI-reportConfig IE includes a reportQuantity IE, and the reportQuantity IE indicates the report may be associated with inter-band interference reporting.

In some examples of the method, UEs, and non-transitory computer-readable medium described herein, the transmission of the report may be based on an occurrence of one or more trigger events.

In some examples of the method, UEs, and non-transitory computer-readable medium described herein, the one or more trigger events include the inter-band interference satisfying a threshold interference, a change in one or more beam pairs, a change in the inter-band interference satisfying a threshold interference change, or any combination thereof.

Some examples of the method, UEs, and non-transitory computer-readable medium described herein may further include operations, features, means, or instructions for receiving control signaling indicative of a set of trigger events including at least the one or more trigger events, where the transmission of the report may be based on reception of the control signaling.

In some examples of the method, UEs, and non-transitory computer-readable medium described herein, the transmission of the report may be via uplink control information (UCI), a MAC-CE message, or both.

In some examples of the method, UEs, and non-transitory computer-readable medium described herein, the measurement of the inter-band interference may be via one or more resources in the first frequency band associated with the one or more downlink communications and the one or more metrics include a respective metric associated with each resource of the one or more resources.

In some examples of the method, UEs, and non-transitory computer-readable medium described herein, the measurement of the inter-band interference may be based on transmission, via one or more resources in the second frequency band, of the one or more uplink communications in accordance with one or more uplink transmission powers, and wherein the one or more metrics comprise a respective metric associated with each uplink transmission power of the one or more uplink transmission powers.

Some examples of the method, UEs, and non-transitory computer-readable medium described herein may further include operations, features, means, or instructions for transmitting assistance information indicative of the one or more uplink transmission powers, and the measurement of the inter-band interference may be via the one or more resources in accordance with one or more uplink transmission powers.

In some examples of the method, UEs, and non-transitory computer-readable medium described herein, measurement of the inter-band interference may be via one or more resources in the first frequency band associated with the one or more downlink communications and the one or more metrics include a first metric associated with a first sub-configuration of the one or more resources and a second metric associated with a second sub-configuration of the one or more resources.

In some examples of the method, UEs, and non-transitory computer-readable medium described herein, the report may be associated with a priority value from a set of priority values and the priority value may be zero, one, or a value different than zero or one associated with multiplexing one or more channel state information (CSI) reports.

In some examples of the method, UEs, and non-transitory computer-readable medium described herein, the transmission of the report may be based on transmission of one or more uplink messages via one or more uplink resources and the one or more uplink resources correspond to one or more downlink resources associated with measurement of the inter-band interference.

In some examples of the method, UEs, and non-transitory computer-readable medium described herein, the one or more metrics include a first received signal strength indicator (RSSI) associated with an absence of the inter-band interference and include a second RSSI associated with a presence of the inter-band interference.

In some examples of the method, UEs, and non-transitory computer-readable medium described herein, the measurement of the inter-band interference may be performed autonomously by the UE and the transmission of the report may be via an uplink grant, a MAC-CE message, one or more periodic uplink resources, or any combination thereof, based on measurement of the inter-band interference being performed autonomously by the UE.

In some examples of the method, UEs, and non-transitory computer-readable medium described herein, the UE may be associated with a set of multiple beam pairs, the measurement of the inter-band interference may be associated with a subset of the set of multiple beam pairs, and the report may be indicative of the inter-band interference associated with the set of multiple beam pairs based on inputting the inter-band interference associated with the subset of the set of multiple beam pairs into a machine learning model.

Some examples of the method, UEs, and non-transitory computer-readable medium described herein may further include operations, features, means, or instructions for receiving control signaling indicative of configuration information associated with the report, where the configuration information may be indicative of a quantity measurement resources to be reported by the UE, and where the transmission of the report may be based on reception of the control signaling.

In some examples of the method, UEs, and non-transitory computer-readable medium described herein, measurement of the inter-band interference may be via one or more resources in the first frequency band associated with the one or more downlink communications, each resource of the one or more resources may be associated with a beam pair from a set of multiple beam pairs, and the one or more metrics include a respective metric associated with each beam pair from the set of multiple beam pairs.

In some examples of the method, UEs, and non-transitory computer-readable medium described herein, the one or more metrics include an indication of a first inter-band interference associated with a first beam pair of the set of multiple beam pairs and include an indication of a respective differential from the first inter-band interference associated with each other beam pair of the set of multiple beam pairs and the first inter-band interference may be a highest inter-band interference from among the set of multiple beam pairs.

In some examples of the method, UEs, and non-transitory computer-readable medium described herein, measurement of the inter-band interference may be via one or more resources in the first frequency band associated with the one or more downlink communications, the one or more metrics include an indication of a first inter-band interference associated with a first resource of the one or more resources and include an indication of a respective differential from the first inter-band interference associated with each other resource of the one or more resources, and the first inter-band interference may be a highest inter-band interference from among the one or more resources.

In some examples of the method, UEs, and non-transitory computer-readable medium described herein, transmitting the report may include operations, features, means, or instructions for transmitting a negative acknowledgment (NACK) message based on failure to receive the one or more downlink communications, where the NACK message includes the indication of the one or more metrics associated with the inter-band interference based at in part on failure of the UE to receive the one or more downlink communications being based on the inter-band interference.

Some examples of the method, UEs, and non-transitory computer-readable medium described herein may further include operations, features, means, or instructions for receiving control signaling indicative of one or more interference measurement resources associated with the measurement, in the first frequency band associated with the one or more downlink communications, of the inter-band interference, where the measurement of the inter-band interference may be based on reception of the control signaling.

In some examples of the method, UEs, and non-transitory computer-readable medium described herein, the one or more metrics include a first channel quality indicator (CQI) associated with an absence of the inter-band interference and include a second CQI associated with a presence of the inter-band interference.

In some examples of the method, UEs, and non-transitory computer-readable medium described herein, the one or more metrics include a first CQI associated with a first sub-configuration of the UE and include a second CQI associated with a second sub-configuration of the UE.

In some examples of the method, UEs, and non-transitory computer-readable medium described herein, the one or more metrics include a first CQI associated with a first set of frequency resources, a first set of sub-bands, a first set of RBs (RBs), or any combination thereof and a second CQI associated with a second set of frequency resources, a second set of sub-bands, a second set of RBs, or any combination thereof.

In some examples of the method, UEs, and non-transitory computer-readable medium described herein, the one or more metrics include a report quantity indicative of a first CQI associated with an absence of the inter-band interference and a value of the inter-band interference.

In some examples of the method, UEs, and non-transitory computer-readable medium described herein, the one or more metrics include the report quantity and, the value of the inter-band interference includes a differential value relative to a reference value, and the transmission of the report may be based on the differential value satisfying a threshold differential value.

Some examples of the method, UEs, and non-transitory computer-readable medium described herein may further include operations, features, means, or instructions for receiving control signaling scheduling one or more uplink transmissions via one or more uplink resources associated with the measurement of the inter-band interference, and where the transmission of the report may be based on the one or more uplink transmissions being scheduled on the one or more uplink resources.

Some examples of the method, UEs, and non-transitory computer-readable medium described herein may further include operations, features, means, or instructions for transmitting one or more of a buffer status report (BSR), a power headroom report, a configured payload, or any combination thereof, based on no uplink data being scheduled via one or more uplink resource associated with the measurement of the inter-band interference.

In some examples of the method, UEs, and non-transitory computer-readable medium described herein, one or more configured grant (CG) configuration identifiers, one or more SRS resource identifiers, or both, may be associated with the report and the one or more CG configuration identifiers, the one or more SRS resource identifiers, or both, may be associated with one or more uplink resource associated with the measurement of the inter-band interference.

Some examples of the method, UEs, and non-transitory computer-readable medium described herein may further include operations, features, means, or instructions for CG skipping may be disabled for one or more CGs associated with the one or more CG configuration identifiers.

In some examples of the method, UEs, and non-transitory computer-readable medium described herein, the report includes an indication of whether the inter-band interference satisfies one or more interference thresholds, an indication to exclude one or more RBs, a range of RBs, or both, associated with the inter-band interference satisfying the one or more interference thresholds, or both.

In some examples of the method, UEs, and non-transitory computer-readable medium described herein, the report includes the indication of whether the inter-band interference satisfies the one or more interference thresholds per RB, per RB level, or both.

Some examples of the method, UEs, and non-transitory computer-readable medium described herein may further include operations, features, means, or instructions for transmitting a capability message indicative of whether the UE supports reporting of the inter-band interference, where the measurement of the inter-band interference may be based on transmission of the capability message.

In some examples of the method, UEs, and non-transitory computer-readable medium described herein, the capability message may be indicative of whether the UE supports RSSI-based inter-band interference reporting, CQI-based inter-band interference reporting, or both.

In some examples of the method, UEs, and non-transitory computer-readable medium described herein, the capability message may be indicative of whether the UE supports each feature of one or more first features associated with RSSI-based inter-band interference reporting, whether the UE supports each feature of one or more second features associated with CQI-based inter-band interference reporting, or both.

In some examples of the method, UEs, and non-transitory computer-readable medium described herein, the first frequency may be 7 gigahertz (GHz) and the second frequency may be 3.5 GHz.

In some examples of the method, UEs, and non-transitory computer-readable medium described herein, the inter-band interference may be due to second harmonics between the first frequency band and the second frequency band in accordance with the first frequency of the first frequency band being double the second frequency of the second frequency band.

In some examples of the method, UEs, and non-transitory computer-readable medium described herein, the inter-band interference may be associated with inter-band carrier aggregation (CA), inter-band dual connectivity (DC), or both.

A method for wireless communications by a network entity is described. The method may include outputting control signaling indicative of one or more resources associated with measurement of inter-band interference between one or more uplink communications received by the network entity and one or more downlink communications transmitted by the network entity, where the inter-band interference is based on a first frequency of a first frequency band associated with the one or more downlink communications being double a second frequency of a second frequency band associated with the one or more uplink communications and obtaining a report indicative of the inter-band interference based on the output of the control signaling, where the report includes an indication of one or more metrics associated with the inter-band interference.

A network entity for wireless communications is described. The network entity may include one or more memories storing processor executable code, and one or more processors coupled with the one or more memories. The one or more processors may individually or collectively be operable to execute the code to cause the network entity to output control signaling indicative of one or more resources associated with measurement of inter-band interference between one or more uplink communications received by the network entity and one or more downlink communications transmitted by the network entity, where the inter-band interference is based on a first frequency of a first frequency band associated with the one or more downlink communications being double a second frequency of a second frequency band associated with the one or more uplink communications and obtain a report indicative of the inter-band interference based on the output of the control signaling, where the report includes an indication of one or more metrics associated with the inter-band interference.

Another network entity for wireless communications is described. The network entity may include means for outputting control signaling indicative of one or more resources associated with measurement of inter-band interference between one or more uplink communications received by the network entity and one or more downlink communications transmitted by the network entity, where the inter-band interference is based on a first frequency of a first frequency band associated with the one or more downlink communications being double a second frequency of a second frequency band associated with the one or more uplink communications and means for obtaining a report indicative of the inter-band interference based on the output of the control signaling, where the report includes an indication of one or more metrics associated with the inter-band interference.

A non-transitory computer-readable medium storing code for wireless communications is described. The code may include instructions executable by one or more processors to output control signaling indicative of one or more resources associated with measurement of inter-band interference between one or more uplink communications received by the network entity and one or more downlink communications transmitted by the network entity, where the inter-band interference is based on a first frequency of a first frequency band associated with the one or more downlink communications being double a second frequency of a second frequency band associated with the one or more uplink communications and obtain a report indicative of the inter-band interference based on the output of the control signaling, where the report includes an indication of one or more metrics associated with the inter-band interference.

Some examples of the method, network entities, and non-transitory computer-readable medium described herein may further include operations, features, means, or instructions for obtaining, from a second network entity, an indication of one or more second resources associated with measurement of inter-band interference between one or more second uplink communications received by the second network entity and one or more second downlink communications transmitted by the second network entity and refraining from communicating via the one or more second resources based on reception of the indication.

In some examples of the method, network entities, and non-transitory computer-readable medium described herein, the one or more resources associated with the measurement of the inter-band interference may be periodic, semi-persistent, or aperiodic.

In some examples of the method, network entities, and non-transitory computer-readable medium described herein, the control signaling indicates one or more resource identifiers associated with the one or more resources associated with an inter-band interference resource set, an index associated with a first resource of the one or more resources, a quantity of the one or more resources, a symbol associated with the first resource of the one or more resources within a slot, a quantity of symbols associated with the one or more resources within the slot, a periodicity and a slot offset associated with the one or more resources, a subcarrier spacing associated with the one or more resources, QCL information, with a QCL type set to ‘typeD,’ associated with the one or more resources, or any combination thereof.

In some examples of the method, network entities, and non-transitory computer-readable medium described herein, the QCL information includes a list of TCI states and measurement of each of the one or more resources may be in accordance with a TCI state from the list of TCI states.

In some examples of the method, network entities, and non-transitory computer-readable medium described herein, measurement of the one or more resources may be in accordance with a TCI state associated with one of a last received downlink shared channel message prior to the one or more resources and a last monitored control resource set prior to the one or more resources based on the QCL information not being configured and based on unifiedTCI-StateType not being configured.

In some examples of the method, network entities, and non-transitory computer-readable medium described herein, measurement of the one or more resources may be in accordance with a TCI state associated with an indicated downlink only TCI state, an indicated joint TCI state, or both, prior to the one or more resources based on the QCL information not being configured and based on unifiedTCI-StateType being configured.

In some examples of the method, network entities, and non-transitory computer-readable medium described herein, the one or more resources may be periodic resources, each resource of the one or more resources may be associated with a respective TCI state configure per resource of the one or more resources in accordance with one or more respective parameters, and measurement of the one or more resources may be in accordance with the respective TCI states.

In some examples of the method, network entities, and non-transitory computer-readable medium described herein, the control signaling includes an activation or deactivation MAC-CE message, the activation or deactivation MAC-CE message includes one or more fields indictive of one or more TCI states associated with the one or more resources, and measurement of the one or more resources may be in accordance with the one or more TCI states.

In some examples of the method, network entities, and non-transitory computer-readable medium described herein, reception of the report may be based on reception of one or more uplink messages via one or more second resources in the second frequency band associated with the one or more uplink communications, the one or more second resources at least partially overlap the one or more resources, and the one or more uplink messages includes one or more SRSs, one or more DMRSs, one or more uplink reference signals, or any combination thereof.

In some examples of the method, network entities, and non-transitory computer-readable medium described herein, the one or more uplink messages may be received in accordance with an uplink transmission power and the uplink transmission power may be a default transmission power, may be based on an indication from the network entity, may be based on a range of uplink transmission powers, or any combination thereof.

In some examples of the method, network entities, and non-transitory computer-readable medium described herein, the control signaling includes a CSI-ResourceConfig IE and the CSI-ResourceConfig IE may be indicative of an interference measurement resource set list including the one or more resources.

In some examples of the method, network entities, and non-transitory computer-readable medium described herein, the control signaling includes a CSI-ResourceConfig IE and the CSI-ResourceConfig IE includes an indication of an identifier of a resource configuration associated with the one or more resources.

In some examples of the method, network entities, and non-transitory computer-readable medium described herein, the control signaling includes a CSI-IM IE indicative of the one or more resources.

In some examples of the method, network entities, and non-transitory computer-readable medium described herein, the one or more resources include an set of aperiodic resources, the control signaling may be DCI signaling in an aperiodic inter-band interference resource set configuration, and the obtaining of the report may be in accordance with a slot offset between a first slot associated with the DCI signaling that triggers the set of aperiodic resources and a second slot in which the set of aperiodic resources may be measured by a UE.

Some examples of the method, network entities, and non-transitory computer-readable medium described herein may further include operations, features, means, or instructions for outputting second control signaling indicative of configuration information associated with the report, where the obtaining of the report may be based on the output of the second control signaling.

In some examples of the method, network entities, and non-transitory computer-readable medium described herein, the second control signaling may be indicative of a sub-band size, a quantity of sub-bands, or both and the one or more metrics include one or more respective metrics associated with each sub-band among the quantity of sub-bands.

In some examples of the method, network entities, and non-transitory computer-readable medium described herein, the second control signaling indicates that the report may be a wideband report.

In some examples of the method, network entities, and non-transitory computer-readable medium described herein, the report may be aperiodic, periodic, or semi-persistent.

In some examples of the method, network entities, and non-transitory computer-readable medium described herein, the second control signaling includes a CSI-reportConfig IE, the CSI-reportConfig IE includes a reportQuantity IE, and the reportQuantity IE indicates the report may be associated with inter-band interference reporting.

In some examples of the method, network entities, and non-transitory computer-readable medium described herein, the obtaining of the report may be based on an occurrence of one or more trigger events.

In some examples of the method, network entities, and non-transitory computer-readable medium described herein, the one or more trigger events include the inter-band interference satisfying a threshold interference, a change in one or more beam pairs, a change in the inter-band interference satisfying a threshold interference change, or any combination thereof.

Some examples of the method, network entities, and non-transitory computer-readable medium described herein may further include operations, features, means, or instructions for outputting second control signaling indicative of a set of trigger events including at least the one or more trigger events, where the obtaining of the report may be based on the output of the second control signaling.

In some examples of the method, network entities, and non-transitory computer-readable medium described herein, the output of the report may be via UCI, a MAC-CE message, or both.

In some examples of the method, network entities, and non-transitory computer-readable medium described herein, measurement of the inter-band interference may be via one or more resources in the first frequency band associated with the one or more downlink communications and the one or more metrics include a respective metric associated with each resource of the one or more resources.

In some examples of the method, network entities, and non-transitory computer-readable medium described herein, the one or more metrics include a respective metric associated with each resource of the one or more resources associated with one or more uplink transmission powers.

In some examples of the method, network entities, and non-transitory computer-readable medium described herein, measurement of the inter-band interference may be via one or more resources in the first frequency band associated with the one or more downlink communications and the one or more metrics include a first metric associated with a first sub-configuration of the one or more resources and a second metric associated with a second sub-configuration of the one or more resources.

In some examples of the method, network entities, and non-transitory computer-readable medium described herein, the report may be associated with a priority value from a set of priority values and the priority value may be zero, one, or a value different than zero or one associated with multiplexing one or more CSI reports.

In some examples of the method, network entities, and non-transitory computer-readable medium described herein, the obtaining of the report may be based on reception of one or more uplink messages via one or more uplink resources and the one or more uplink resources correspond to one or more downlink resources associated with measurement of the inter-band interference.

In some examples of the method, network entities, and non-transitory computer-readable medium described herein, the one or more metrics include a first RSSI associated with an absence of the inter-band interference and include a second RSSI associated with a presence of the inter-band interference.

Some examples of the method, network entities, and non-transitory computer-readable medium described herein may further include operations, features, means, or instructions for outputting second control signaling indicative of configuration information associated with the report, where the configuration information may be indicative of a quantity measurement resources to be reported by a UE, and where the obtaining of the report may be based on transmission of the second control signaling.

In some examples of the method, network entities, and non-transitory computer-readable medium described herein, the network entity may be associated with a set of multiple beam pairs and the report may be indicative of the inter-band interference associated with the set of multiple beam pairs.

In some examples of the method, network entities, and non-transitory computer-readable medium described herein, the one or more metrics include an indication of a first inter-band interference associated with a first beam pair of the set of multiple beam pairs and include an indication of a respective differential from the first inter-band interference associated with each other beam pair of the set of multiple beam pairs and the first inter-band interference may be a highest inter-band interference from among the set of multiple beam pairs.

In some examples of the method, network entities, and non-transitory computer-readable medium described herein, measurement of the inter-band interference may be via one or more resources in the first frequency band associated with the one or more downlink communications, the one or more metrics include an indication of a first inter-band interference associated with a first resource of the one or more resources and include an indication of a respective differential from the first inter-band interference associated with each other resource of the one or more resources, and the first inter-band interference may be a highest inter-band interference from among the one or more resources.

Some examples of the method, network entities, and non-transitory computer-readable medium described herein may further include operations, features, means, or instructions for receiving a NACK message indicating failure of a UE to receive the one or more downlink communications, where the NACK message includes the indication of the one or more metrics associated with the inter-band interference based at in part on failure of the UE to receive the one or more downlink communications being based on the inter-band interference.

In some examples of the method, network entities, and non-transitory computer-readable medium described herein, the one or more metrics include a first CQI associated with an absence of the inter-band interference and include a second CQI associated with a presence of the inter-band interference.

In some examples of the method, network entities, and non-transitory computer-readable medium described herein, the one or more metrics include a first CQI associated with a first sub-configuration of a UE and include a second CQI associated with a second sub-configuration of the UE.

In some examples of the method, network entities, and non-transitory computer-readable medium described herein, the one or more metrics include a first CQI associated with a first set of frequency resources, a first set of sub-bands, a first set of RBs, or any combination thereof and a second CQI associated with a second set of frequency resources, a second set of sub-bands, a second set of RBs, or any combination thereof.

In some examples of the method, network entities, and non-transitory computer-readable medium described herein, the one or more metrics include a report quantity indicative of a first CQI associated with an absence of the inter-band interference and a value of the inter-band interference.

In some examples of the method, network entities, and non-transitory computer-readable medium described herein, the one or more metrics include the report quantity and, the value of the inter-band interference includes a differential value relative to a reference value, and reception of the report may be based on the differential value satisfying a threshold differential value.

Some examples of the method, network entities, and non-transitory computer-readable medium described herein may further include operations, features, means, or instructions for outputting second control signaling scheduling one or more uplink transmissions via one or more uplink resources associated with measurement of the inter-band interference, and where the obtaining of the report may be based on the one or more uplink transmissions being scheduled on the one or more uplink resources.

Some examples of the method, network entities, and non-transitory computer-readable medium described herein may further include operations, features, means, or instructions for obtaining one or more of a BSR, a power headroom report, a configured payload, or any combination thereof, based on no uplink data being scheduled via one or more uplink resource associated with measurement of the inter-band interference.

In some examples of the method, network entities, and non-transitory computer-readable medium described herein, one or more CG configuration identifiers, one or more SRS resource identifiers, or both, may be associated with the report and the one or more CG configuration identifiers, the one or more SRS resource identifiers, or both, may be associated with one or more uplink resource associated with measurement of the inter-band interference.

Some examples of the method, network entities, and non-transitory computer-readable medium described herein may further include operations, features, means, or instructions for CG skipping may be disabled for one or more CGs associated with the one or more CG configuration identifiers.

In some examples of the method, network entities, and non-transitory computer-readable medium described herein, the report includes an indication of whether the inter-band interference satisfies one or more interference thresholds, an indication to exclude one or more RBs, a range of RBs, or both, associated with the inter-band interference satisfying the one or more interference thresholds, or both.

In some examples of the method, network entities, and non-transitory computer-readable medium described herein, the report includes the indication of whether the inter-band interference satisfies the one or more interference thresholds per RB, per RB level, or both.

Some examples of the method, network entities, and non-transitory computer-readable medium described herein may further include operations, features, means, or instructions for obtaining a capability message indicative of whether a UE supports reporting of the inter-band interference, where the obtaining of the report may be based on transmission of the capability message.

In some examples of the method, network entities, and non-transitory computer-readable medium described herein, the capability message may be indicative of whether the UE supports RSSI-based inter-band interference reporting, CQI-based inter-band interference reporting, or both.

In some examples of the method, network entities, and non-transitory computer-readable medium described herein, the capability message may be indicative of whether the UE supports each feature of one or more first features associated with RSSI-based inter-band interference reporting, whether the UE supports each feature of one or more second features associated with CQI-based inter-band interference reporting, or both.

In some examples of the method, network entities, and non-transitory computer-readable medium described herein, the first frequency may be 7 GHz and the second frequency may be 3.5 GHz.

In some examples of the method, network entities, and non-transitory computer-readable medium described herein, the inter-band interference may be due to second harmonics between the first frequency band and the second frequency band in accordance with the first frequency of the first frequency band being double the second frequency of the second frequency band.

In some examples of the method, network entities, and non-transitory computer-readable medium described herein, the inter-band interference may be associated with inter-band CA, inter-band DC, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for inter-band interference measurement and reporting in accordance with one or more aspects of the present disclosure.

FIG. 2 shows an example of a wireless communications system that supports techniques for inter-band interference measurement and reporting in accordance with one or more aspects of the present disclosure.

FIG. 3 shows an example of a process flow that supports techniques for inter-band interference measurement and reporting in accordance with one or more aspects of the present disclosure.

FIGS. 4 and 5 show block diagrams of devices that support techniques for inter-band interference measurement and reporting in accordance with one or more aspects of the present disclosure.

FIG. 6 shows a block diagram of a communications manager that supports techniques for inter-band interference measurement and reporting in accordance with one or more aspects of the present disclosure.

FIG. 7 shows a diagram of a system including a device that supports techniques for inter-band interference measurement and reporting in accordance with one or more aspects of the present disclosure.

FIGS. 8 and 9 show block diagrams of devices that support techniques for inter-band interference measurement and reporting in accordance with one or more aspects of the present disclosure.

FIG. 10 shows a block diagram of a communications manager that supports techniques for inter-band interference measurement and reporting in accordance with one or more aspects of the present disclosure.

FIG. 11 shows a diagram of a system including a device that supports techniques for inter-band interference measurement and reporting in accordance with one or more aspects of the present disclosure.

FIGS. 12 and 13 show flowcharts illustrating methods that support techniques for inter-band interference measurement and reporting in accordance with one or more aspects of the present disclosure.

### DETAILED DESCRIPTION

Some wireless communications systems may support simultaneous transmission and reception of communications. For example, a user equipment (UE) may simultaneously transmit one or more uplink messages and receive one or more downlink messages in accordance with a frequency division duplex (FDD) communication scheme, in accordance with inter-band carrier aggregation (CA), in accordance with a dual-connectivity (DC) communication scheme, or any combination thereof. In some cases, the one or more uplink messages transmitted by the UE via a first frequency band may cause inter-band interference with the one or more downlink messages received by the UE via a second frequency band. In such cases, when a difference between a first frequency of the first frequency band and a second frequency of the second frequency band is greater than a threshold, the UE may reduce or resolve the inter-band interference via UE implementation. For example, the UE may reduce an analog to digital (ADC) setpoint of the UE, may reduce an analog front end (AFE) setpoint of the UE, or both, to reduce or resolve the inter-band interference. However, in some cases, the difference between the first frequency of the first frequency band and the second frequency of the second frequency band may be less than the threshold, the second frequency may be double the first frequency (e.g., the second frequency may be a second harmonic frequency and the first frequency may be a fundamental frequency), or both. For example, the UE may transmit the one or more uplink messages via a 3.5 GHz frequency band (e.g., C band, 5th Generation (5G) band) and may receive the one or more downlink messages via a 7 GHz band (e.g., 6th Generation (6G) band). In such cases, the UE may be unable to resolve (e.g., or it may be inefficient for the UE to attempt to resolve) the inter-band interference via UE implementation due to the inter-band interference being stronger (e.g., being a higher level of interference) than when the difference between the first frequency and the second frequency is greater than the threshold, when the second frequency is not double the first frequency, or both.

Accordingly, techniques described herein may support inter-band interference measurement and reporting by the UE. In some examples, the inter-band interference measurement and reporting may be via measurement and reporting of one or more received signal strength indicators (RSSIs). For example, the UE may receive control signaling (e.g., CSI-ResourceConfig) indicating one or more downlink resources in the second frequency band that are to be measured by the UE for inter-band interference. Thus, the UE may measure the one or more downlink resources and may identify (e.g., generate) a first RSSI associated with the one or more downlink resources when inter-band interference is not present on the one or more downlink resources and a second RSSI associated with the one or more downlink resources when inter-band interference is present on the one or more downlink resources. In some examples, the UE may transmit a report indicative of the first RSSI and the second RSSI (e.g., indicative of the inter-band interference) periodically, a-periodically, or semi-persistently. In some other cases, the UE may transmit the report based on one or more trigger events, such as when the second RSSI changes by more than a threshold RSSI change, when a beam pair associated with the UE changes, when the second RSSI exceeds a threshold RSSI, or any combination thereof. Thus, the network entity may adjust one or more parameters associated with downlink communications to the UE based on the inter-band interference (e.g., indicated via the report).

Additionally, or alternatively, the inter-band interference measurement and reporting may be via measurement and reporting of one or more channel quality indicators (CQIs) (e.g., or one or more signal-to-interference and noise ratios (SINRs)) For example, the UE may receive control signaling (e.g., interference measurement resource (IMR) signaling) indicating one or more downlink resources in the second frequency band that are to be measured by the UE for inter-band interference. Thus, the UE may measure the one or more downlink resources and may identify (e.g., generate) one or more CQIs in accordance with the measurement. For example, in some cases, the UE may generate a first CQI associated with the one or more downlink resources when inter-band interference is not present on the one or more downlink resources and a second CQI associated with the one or more downlink resources when inter-band interference is present on the one or more downlink resources. Additionally, or alternatively, the UE may generate the first CQI and a value indicative of the inter-band interference. In some examples, the value may be an explicit value of the inter-band interference or may be a differential value relative to a reference value. Thus, the UE may transmit a report indicative of the one or more CQIs periodically, a-periodically, or semi-persistently. In some cases, the UE may transmit the report based on uplink communications being scheduled via one or more uplink resources in the first frequency band associated with measurement of the inter-band interference. That is, the one or more uplink resources may at least partially overlap (e.g., in a time domain) with the one or more downlink resources, such that when no uplink communications are scheduled on the one or more uplink resources, no inter-band interference may be present on the one or more downlink resources. Thus, the network entity may adjust one or more parameters associated with downlink communications to the UE based on the inter-band interference (e.g., indicated via the report).

Though described in the context of RSSI-based inter-band interference measurement and reporting and CQI-based inter-band interference measurement and reporting, this is not to be regarded as a limitation of the present disclosure. In this regard, techniques described herein may be applicable to any type of inter-band interference measurement and reporting. For example, techniques described herein in the context of CQI-based inter-band interference measurement and reporting may additionally, or alternatively, be applicable to RSSI-based inter-band interference measurement and reporting (e.g., and/or visa-versa). Similarly, techniques described herein in the context of SINR-based inter-band interference measurement and reporting.

Aspects of the disclosure are initially described in the context of wireless communications systems. Aspects of the disclosure are then described in the context of a process flow. Aspects of the disclosure are further illustrated by and described with reference to apparatus diagrams, system diagrams, and flowcharts that relate to techniques for inter-band interference measurement and reporting.

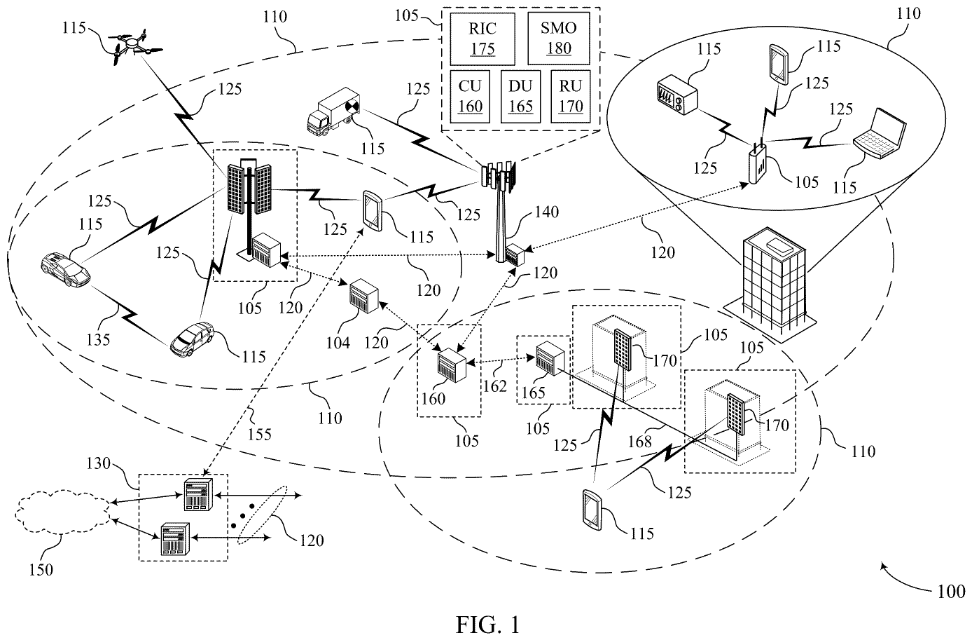

FIG. 1 shows an example of a wireless communications system 100 that supports techniques for inter-band interference measurement and reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for inter-band interference measurement and reporting as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation (CA) configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system 200 may support inter-band interference measurement and reporting by a UE 115. In some examples, the inter-band interference measurement and reporting may be via measurement and reporting of one or more RSSIs. For example, the UE 115 may receive control signaling (e.g., CSI-ResourceConfig) indicating one or more downlink resources in the second frequency band that are to be measured by the UE 115 for inter-band interference. Thus, the UE 115 may measure the one or more downlink resources and may identify (e.g., generate) a first RSSI associated with the one or more downlink resources when inter-band interference is not present on the one or more downlink resources and a second RSSI associated with the one or more downlink resources when inter-band interference is present on the one or more downlink resources. In some examples, the UE 115 may transmit a report indicative of the first RSSI and the second RSSI (e.g., indicative of the inter-band interference) periodically, a-periodically, or semi-persistently. In some other cases, the UE 115 may transmit the report based on one or more trigger events, such as when the second RSSI changes by more than a threshold RSSI change, when a beam pair associated with the UE 115 changes, when the second RSSI exceeds a threshold RSSI, or any combination thereof. Thus, a network entity 105 may adjust one or more parameters associated with downlink communications to the UE 115 based on the inter-band interference (e.g., indicated via the report).

Additionally, or alternatively, the inter-band interference measurement and reporting may be via measurement and reporting of one or more CQIs (e.g., or one or more SINRs) For example, the UE 115 may receive control signaling (e.g., IMR signaling) indicating one or more downlink resources in the second frequency band that are to be measured by the UE 115 for inter-band interference. Thus, the UE 115 may measure the one or more downlink resources and may identify (e.g., generate) one or more CQIs in accordance with the measurement. For example, in some cases, the UE 115 may generate a first CQI associated with the one or more downlink resources when inter-band interference is not present on the one or more downlink resources and a second CQI associated with the one or more downlink resources when inter-band interference is present on the one or more downlink resources. Additionally, or alternatively, the UE 115 may generate the first CQI and a value indicative of the inter-band interference. In some examples, the value may be an explicit value of the inter-band interference or may be a differential value relative to a reference value. Thus, the UE 115 may transmit a report indicative of the one or more CQIs periodically, a-periodically, or semi-persistently. In some cases, the UE 115 may transmit the report based on uplink communications being scheduled via one or more uplink resources in the first frequency band associated with measurement of the inter-band interference. That is, the one or more uplink resources may at least partially overlap (e.g., in a time domain) with the one or more downlink resources, such that when no uplink communications are scheduled on the one or more uplink resources, no inter-band interference may be present on the one or more downlink resources. Thus, the network entity 105 may adjust one or more parameters associated with downlink communications to the UE 115 based on the inter-band interference (e.g., indicated via the report).

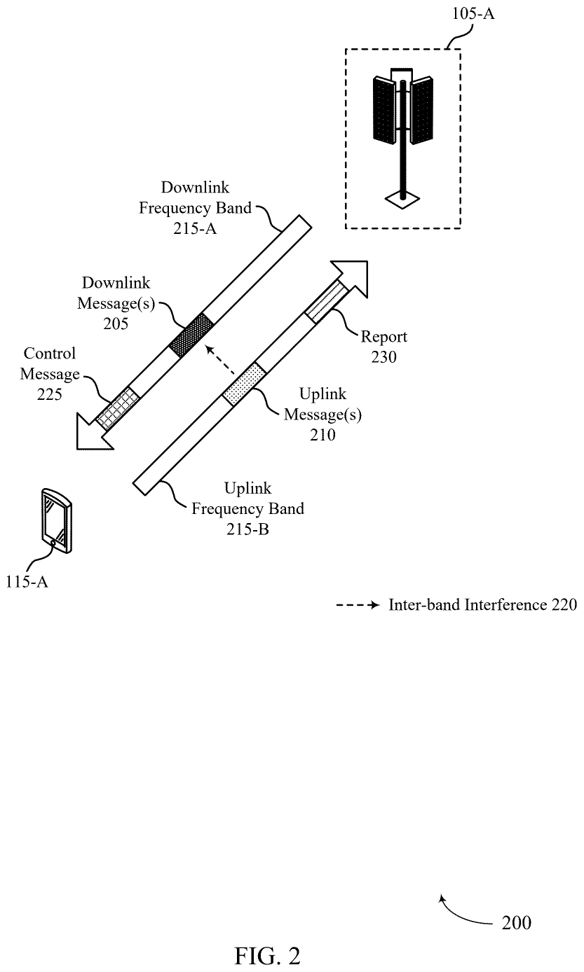

FIG. 2 shows an example of a wireless communications system 200 that supports techniques for inter-band interference measurement and reporting in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

Some wireless communications systems may support simultaneous transmission and reception of communications. For example, a UE 115, such as the UE 115-a, may transmit one or more uplink messages 210 simultaneously with reception of one or more downlink messages 205 in accordance with an FDD communication scheme, in accordance with inter-band CA, in accordance with a DC communication scheme, or any combination thereof. In some cases, the one or more uplink messages 210 transmitted by the UE 115-a via an uplink frequency band 215-b may cause inter-band interference 220 (e.g., inter-band self-interference) with the one or more downlink messages 205 received by the UE 115-a via a downlink frequency band 215-a. That is, the one or more uplink messages 210 may cause a jammer condition at a receiver of the UE 115-a. In such cases, when a difference between a first frequency of the uplink frequency band 215-b and a second frequency of the downlink frequency band 215-a is greater than a threshold, the UE 115-a may reduce or resolve the inter-band interference 220 via UE implementation (e.g., at an RF front end). For example, the UE 115-a may reduce an ADC setpoint of the UE 115-a, may reduce an AFE setpoint of the UE 115-a, or both, to reduce or resolve the inter-band interference 220.

However, in some cases, the difference between the first frequency of the uplink frequency band 215-b and the second frequency of the downlink frequency band 215-a may be less than the threshold, the second frequency of the downlink frequency band 215-a may be double the first frequency of the uplink frequency band 215-b (e.g., or visa-versa), or both. For example, the uplink frequency band 215-b may be a 3.5 GHz frequency band (e.g., C band, 5th Generation (5G) band) and the downlink frequency band 215-a may be a 7 GHz band (e.g., 6th Generation (6G) band, 6-8 gigahertz (GHz) band). In such cases, the inter-band interference 220 may be due to a second harmonic relationship between the first frequency and the second frequency. That is, the second frequency of the downlink frequency band 215-a (e.g., f2) may be a second harmonic frequency and the first frequency of the uplink frequency band 215-b (e.g., f1) may be a fundamental frequency (e.g., of the second harmonic frequency) based on the second frequency being double (e.g., twice) the first frequency (e.g., f2=2*f1). The second harmonic frequency may indicate where distortion between the one or more uplink messages 210 and the one or more downlink messages 205 falls, where second order intermodulation distortion (IMD2) may indicate a second order of the distortion and fourth order intermodulation distortion (IMD4) may indicate a fourth order of the distortion (e.g., which both fall on the second harmonic frequency). For example, if the one or more uplink messages 210 are allocated 4 resource blocks (RBs) in the first frequency band (e.g., f1), then IMD2 causes interference on (e.g., leaks on) 8 RBs on the second frequency (e.g., f2) and IMD4 causes interference on 16 RBs on the second frequency (e.g., f2), where the interference caused by IMD4 is less than the interference caused by IMD2. Thus, the one or more uplink messages 210 may cause non-uniform interference with reception of the one or more downlink messages 205. While the one or more uplink messages 210 may cause the inter-band interference 220 with the one or more downlink messages 205, the interference may not be symmetric, such that the one or more downlink messages 205 may not cause inter-band interference 220 with the one or more uplink messages 210.

In such cases, the UE 115-a may be unable to resolve (e.g., or it may be inefficient for the UE 115-a to attempt to resolve) the inter-band interference 220 via UE implementation (e.g., when flexible TDD is enabled between the UE 115-a and the network entity 105-a) due to the inter-band interference 220 being stronger (e.g., being a higher level of interference) than when the difference between the first frequency of the uplink frequency band 215-b and the second frequency of the downlink frequency band 215-a is greater than the threshold, when the second frequency of the downlink frequency band 215-a is not double the first frequency of the uplink frequency band 215-b, or both.

Accordingly, techniques described herein may support measurement and reporting of inter-band interference 220 (e.g., intra-UE interference, self-interference). In some cases, the UE 115-a may support RSSI-based inter-band interference measurement and reporting. For example, the UE 115-a may receive a control message 225 indicative of one or more downlink resources in the frequency band 215-a to be measured by the UE 115-a for inter-band interference 220, where the one or more downlink resources may be periodic, aperiodic, semi-persistent, or any combination thereof. In such cases, the control message 225 may indicate one or more parameters associated with the one or more downlink resources in the frequency band 215-a. For example, the one or more parameters may include an interference-RSSI measurement resource identifier associated with each downlink resource of the one or more downlink resources, a starting physical resource block (PRB) index associated with the one or more downlink resources, a quantity of PRBs associated with the one or more downlink resources, a starting symbol of the associated with the one or more downlink resources within a slot, a quantity of symbols associated with the one or more downlink resources within the slot, a periodicity and slot offset associated with each downlink resource of the one or more downlink resources, a subcarrier spacing (SCS) associated with the one or more downlink resources, quasi-co-location information (e.g., QCLinfo) associated with the one or more downlink resources, or any combination thereof.

In some cases, the control message 225 may include an indication of a CSI resource configuration (e.g., CSI-ResourceConfig) that further indicates an interference RSSI-measurement resource set list, including the one or more downlink resources, to be used for RSSI-based inter-band interference measurement. For example, a CSI-ReportConfig.

In some cases, measurement of the inter-band interference 220 on the one or more downlink resources may be based on transmission of one or more uplink messages 210 on one or more uplink resources that correspond to (e.g., at least partially overlap with) the one or more downlink resources. In such cases, the one or more uplink messages 210 may be one or more configured sounding reference signals (SRSs), one or more uplink demodulation reference signals (DMRSs), one or more other reference signals, one or more other uplink channels, or any combination thereof. Additionally, or alternatively, a transmit (Tx) power of the one or more uplink messages 210 may be based on a default (e.g., normal) transmission power, may be based on configuration by the network entity 105-a, may be based on a range of pre-configured uplink Tx powers associated with inter-band interference measurement, may be based on an indication from the network entity 105-a, or any combination thereof.

In some cases, the control message 225 may include a CSI-ResourceConfig information element (IE) including an interference-RSSI measurement resource set list indicative of the one or more downlink resources for interference-RSSI measurements (e.g., measurement of the inter-band interference 220). Additionally, or alternatively, a CSI-ReportConfig IE associated with the report 230 may include a resourceForChannelMeasurement IE indicating an identifier of a CSI-ResourceConfig that contains a configuration of the one or more downlink resources for interference-RSSI measurements. Additionally, or alternatively, the control message 225 may include a separate indication of the one or more downlink resources for interference-RSSI measurements (e.g., or via a CSI-IM IE).

Thus, the UE 115-a may measure the inter-band interference 220 (e.g., via the one or more downlink resources in the frequency band 215-a) in accordance with reception of the control message 225 and may generate (e.g., and transmit) a report 230 indicative of the inter-band interference 220 in accordance with the techniques described herein. In other words, the UE 115-a may report the inter-band interference 220 to the network entity 105-a. In some examples, the report 230 may be communicated periodically, semi-persistently, or aperiodically. In some cases, the control message 225 (e.g., or another control message 225) may include configuration information associated with the report 230. For example, as described herein, the control message 225 may include the CSI-ReportConfig IE associated with the report 230, where the CSI-ReportConfig IE includes a reportQuantity IE associated with RSSI-based inter-band interference measurement. In some cases, the configuration information associated with the report 230 may indicate a slot offset between a slot containing a DCI that triggers the one or more downlink resources, which may be aperiodic, and a slot in which the inter-band interference 220 is measured via the one or more downlink resources.

In some cases, the report 230 may be associated with wideband reporting. In some other cases, the report 230 may be associated with sub-band reporting to enable the UE 115-a to report different interference levels on different frequency resources (e.g., due to non-uniform transmission leakage in band A). In such cases, the CSI-ReportConfig IE may indicate a sub-band size, a quantity of sub-bands, or both, associated with reporting the inter-band interference 220. For example, as described herein, if the one or more uplink messages 210 are allocated 4 RBs in the frequency band 215-b (e.g., f1), then IMD2 causes interference on (e.g., leaks on) 8 RBs on the frequency band 215-a (e.g., f2), where 4 center RBs of the 8 RBs may be associated with a higher level of inter-band interference 220 than 2 edge RBs on each edge of the 8 RBs. Similarly, IMD4 causes interference on 16 RBs on the frequency band 215-a (e.g., f2), where 4 center RBs of the 16 RBs may be associated with a higher level of inter-band interference 220 than 6 edge RBs on each edge of the 16 RBs. Thus, the network entity 105-a may configure the one or more downlink resources based on transmission of the one or more uplink messages and based on one or more impacted RBs in the frequency band 215-a.

Additionally, or alternatively, the report 230 may be event-triggered. For example, the network entity 105-a may indicate, to the UE 115-a (e.g., via the control message 225), one or more events that trigger transmission of the report 230, the UE 115-a may be preconfigured with the one or more evens, or both. In some cases, the one or more events may include a measured RSSI of the one or more downlink resources changing by more than a threshold amount, a transmission and reception beam pair changing, the measured RSSI exceeding a threshold RSSI, or any combination thereof. Thus, the UE 115-a may transmit the report 230 based on satisfaction of at least one of the one or more trigger events. In such cases, the UE 115-a may transmit the report 230 via uplink control information (UCI), where a first PUCCH resource (e.g., scheduling request (SR)-like) indicates at least one of the one or more trigger events has occurred and a second PUSCH resource indicates the report 230. Alternatively, the UE 115-a may transmit the report 230 via MAC-CE signaling.

In some examples, the one or more downlink resources configured by the network entity 105-a may include multiple downlink resources (e.g., measurement resource), where each downlink resource of the multiple downlink resources is associated with a different transmission power, a different RB allocation, or both, due to the inter-band interference 220 being dependent on transmission power, RB allocation, or both. In some cases, each downlink resource of the multiple downlink resources may be associated with a respective report configuration, where each report configuration is associated with a different transmission powers, different RB allocation, or both, and the UE 115-a may transmit a respective report 230 for each report configuration. Alternatively, a single report configuration (e.g., CSI report configuration) may be associated with multiple sub-configurations and the UE 115-a may transmit a respective report 230 for each sub-configuration, where each sub-configuration is associated with a different transmission powers, different RB allocation, or both. In some examples, if a transmission power (e.g., or transmission powers) is not configured by the network entity 105-a, the UE 115-a may report the transmission power (e.g., used to measure the one or more downlink resources) to the network entity 105-a via assistance information.

In some cases, the report 230 (e.g., CSI report carrying an L1 interference-RSSI report) may be associated with a priority, Pri_{i,CSI}(y, k, c, s), where a value of k may be zero (e.g., as L1-RSRP), may be one (e.g., as CSI), or may be a value different than zero or one (e.g., k=2). Additionally, or alternatively, to enable accurate interference measurement at the UE 115-a without interference from a neighbor network entity 105, the network entity 105-a may communicate, with the neighbor network entity 105 (e.g., via Xn/F1AP signaling), the configuration information associated with the one or more downlink messages (e.g., interference-RSSI resource configuration), such that the neighbor network entity 105 may mute one or more other resources corresponding to the one or more downlink messages.

In some cases, the UE 115-a may report multiple RSSIs via the report 230. That is, the UE 115-a may measure the one or more downlink resources when the inter-band interference 220 is present to generate a first RSSI (e.g., an RSSI capturing the inter-band interference 220, with the inter-band interference 220) and may measure the one or more downlink resources when the inter-band interference 220 is not present to generate a second RSSI (e.g., a normal RSSI, without the inter-band interference 220). Thus, the UE 115-a may report both the first RSSI and the second RSSI. That is, even in an absence of the inter-band interference 220, noise, an interference floor (e.g., inter-cell interference), or both, may be present on the one or more downlink resources. Thus, reporting both the first RSSI and the second RSSI may enable the network entity 105-a to determine how much of the second RSSI is due to the noise, the interference floor, or both (e.g., the normal RSSI) and how much of the second RSSI is due to the inter-band interference 220.

Additionally, or alternatively, the UE 115-a may autonomously measure and report the inter-band interference 220. In other words, the UE 115-a may measure and report the inter-band interference 220 without receiving an indication of the one or more downlink resources in the frequency band 215-a on which to measure the inter-band interference 220 (e.g., without receiving the control message 225, without receiving a request to measure the inter-band interference 220). For example, the UE 115-a may autonomously measure an RSSI (e.g., interference-RSSI) via one or more uplink channels, one or more uplink reference signals, or both, with on-going transmissions in the uplink frequency band 215-b (e.g., band B) when there is no configured or scheduled downlink reception in the downlink frequency band 215-a and may autonomously measure one or more impacted downlink RBs based on the one or more uplink channels, the one or more uplink reference signals, or both, with the on-going transmissions (e.g., IMD2, IMD4). In such cases, the report 230 may be via an SR on an uplink grant dedicated to the report 230, via a MAC-CE message on an existing uplink grant, via pre-configured PUCCH resources, or any combination thereof.

Additionally, or alternatively, the UE 115-a may report the inter-band interference 220 via a feedback message. That is, the UE 115-a may transmit a feedback message indicating a positive acknowledgment (ACK) or a negative acknowledgment (NACK) based on whether the UE 115-a received and decoded a downlink message 205. Thus, in some cases, when the UE 115-a transmits a NACK via the feedback message, the UE 115-a may additionally indicate whether the NACK was due to the inter-band interference 220 or not. In some cases, a feedback message indicating a NACK and that the NACK was due to the inter-band interference 220 may additionally indicate a value of the inter-band interference 220 (e.g., an instantaneous aggressor band interference impact). Thus, the network entity 105-a may be aware of whether a NACK is a regular NACK (e.g., not due to the inter-band interference 220) or is a NACK due to inter-band interference 220. Additionally, or alternatively, the UE 115-a may support two types of CSI feedback reporting, a first type of CSI feedback reporting where a corresponding CSI report includes an indication of the inter-band interference 220 and a second type of CSI feedback reporting where the CSI report does not include an indication of the inter-band interference 220.

As described herein, the control message 225 may indicate the one or more parameters associated with the one or more downlink resources in the frequency band 215-a, where the one or more parameters may include QCL information associated with the one or more downlink resources. In some cases, an interference level of the inter-band interference 220 may be different per each transmit and receive beam pair, which may simply be referred to as a beam pair, at the UE 115-a (e.g., due to clutter), thus, inter-band interference reporting on a beam level may enable the network entity 105-a to schedule transmissions and perform interference mitigation via selection of one or more beam pairs associated with inter-band interference 220 below a threshold. Thus, the network entity 105-a may transmit an indication of the QCL information (e.g., via the control message 225 to enable the UE 115-a to report inter-band interference 220 on a beam level.

In some cases, such as for aperiodic, periodic, or semi-persistent interference reporting on PUSCH, the UE 115-a may support one or more transmission configuration indicator (TCI) states in accordance with a CSI-AperiodicTriggerStateList. For example, the control message 225 may indicate a CSI-AssociatedReportConfigInfo IE, and a list of one or more TCI states with qcl-Type set to ‘typeD’ may optionally be configured in the CSI-AssociatedReportConfigInfo IE, where the one or more TCI states mat correspond to the one or more downlink resources (e.g., in the set of CLI measurement resources indicated by CSI-AssociatedReportConfigInfo). In some cases, the list of one or more TCI states may be configured (e.g., present) if unifiedTCI-StateType is configured and the one or more downlink resources (e.g., CLI measurement resource(s)) are aperiodic. Alternatively, if the list of one or more TCI states is not configured (e.g., absent) and unifiedTCI-StateType is not configured, the UE 15-a may assume (e.g., for performance interference measurement in FR2), the one or more downlink resources are QCL-ed with ‘typeD’ to one of a latest received PDSCH, a latest monitored control resource set (CORESET), or both. Alternatively, if the list of one or more TCI states is not configured (e.g., absent) and unifiedTCI-StateType is configured, the UE 15-a may assume the one or more downlink resources are associated with a downlink only TCI state, a joint TCI state, or both.

In some cases, such as for aperiodic, periodic, or semi-persistent interference reporting on PUSCH when the one or more downlink resources include a set of periodic downlink resources, one or more TCI states with QCL ‘typeD’ for the one or more downlink resources in the set of periodic downlink resources may be configured per periodic downlink resource (e.g., per interference measurement resource) via one or more higher layer parameters (e.g., either for all resources in the set of periodic downlink resource or none). For example, for each periodic downlink resource in the set of periodic downlink resource, a higher layer parameter may provide a reference to one TCI state in a list of TCI states (e.g., TCI-States) for providing a QCL source and QCL ‘typeD.’ If the list of TCI states is not configured, the UE 115-a may assume determination of the one or more TCI states in accordance with a CSI-AperiodicTriggerStateList., as described herein (e.g., a default rule for aperiodic resources)

In some cases, such as for aperiodic, periodic, or semi-persistent interference reporting on PUSCH when the one or more downlink resources include a set of semi-persistent downlink resources, the network entity 105-a may activate and deactivate the set of semi-persistent downlink resources via transmission of an SP interference measurement resource set activation/deactivation MAC-CE message. In such cases, the SP interference measurement resource set activation/deactivation MAC-CE message may include a TCI state identifier field that may be used by the UE 115-a as a ‘typeD’ QCL source for a semi-persistent downlink resource in the set of semi-persistent downlink resources. In such cases, either all TCI state identifier fields may be present, or no TCI state identifier fields may be present. In the case that one or more TCI state fields are absent, the UE 115-a may assume determination of the one or more TCI states in accordance with a CSI-AperiodicTriggerStateList., as described herein (e.g., the default rule for aperiodic resources).

In some cases, the UE 115-a may use a machine learning (ML) prediction scheme for inter-band interference reporting. For example, the UE 115-a may input one or more first interference measurements (e.g., RSSIs) associated with a first subset of beam pairs into one or more ML models that may output one or more predictions of one or more second interference measurements (e.g., RSSIs) associated with a second subset of beam pairs, such that the UE 115-a may report the one or more first interference measurements and the one or more second interference measurements. Additionally, or alternatively, the network entity 105-a may configure one or more different uplink beams for uplink transmissions for inter-band interference measurement, such that the inter-band interference measurement may be per beam pair.

In some cases, the UE 115-a may measure report inter-band interference 220 for one or more different (e.g., or top) beam pairs. For example, a quantity of the one or more downlink resources (e.g., measurement resources), M (e.g., {1, 2, 3, 4}), may be associated with different beam pairs, such that the UE 115-a may report M measurement resource identifiers. In such cases, the UE 115-a may report an absolute (e.g., not differential) value of a greatest inter-band interference 220, a least inter-band interference 220, or both. Additionally, when M is greater than one, one or more other values of inter-band interference may be reported as respective differential values relative to the greatest inter-band interference 220 or the least inter-band interference 220.

Additionally, or alternatively, the UE 115-a may support CQI-based inter-band interference measurement and reporting (e.g., reporting of inter-band interference 220 via one or more CQIs). For example, the UE 115-a may receive a control message 225 indicative of one or more downlink resources in the frequency band 215-a to be measured by the UE 115-a for inter-band interference 220. In some examples, the control message 225 may indicate the one or more downlink resources via an IMR for interference-RSSI measurement for demodulation, channel state feedback (CSF) computation, or both. In such cases, the one or more downlink resources may be periodic, semi-persistent, or aperiodic. Thus, the UE 115-a may measure the one or more downlink resources to generate one or more CQIs associated with the inter-band interference 220 and may transmit a report 230 indicative of the one or more CQIs, where the report may be periodic, semi-persistent, or aperiodic.

In some cases, the report 230 may include a first component (e.g., existing reportQuantity) associated with CQI-reporting without a presence of the inter-band interference 220 and a second component (e.g., an IMR) associated with CQI-reporting with a presence of the inter-band interference 220. For example, the report 230 may include a first CQI based on measurement of the one or more downlink resources when the inter-band interference 220 is not present (e.g., a normal CQI without considering the inter-band interference 220) and a second CQI based on measurement of the one or more downlink resources when the inter-band interference 220 is present (e.g., another CQI considering the inter-band interference 220). Additionally, or alternatively, the UE 115-a may support a single CSI reporting configuration (e.g., associated with the reportQuantity) that is further associated with multiple sub-configurations (e.g., in accordance with network energy savings (NES) CSI reporting), where a first sub-configuration is associated with the inter-band interference 220 and a second sub-configuration is associated without the inter-band interference 220. Thus, the UE 115-a may report different CQIs for each sub-configuration. Additionally, or alternatively, due to transmission leakage being non-uniform in the frequency band 215-a (e.g., A band), the UE 115-a may report multiple CQIs to corresponding to different inter-band interference levels on different frequency resources, different sub-bands, different resource blocks (RBs), or any combination thereof. For example, the UE 115-a may report a first CQI (e.g., corresponding to a first inter-band interference level) associated with a first sub-band from a set of sub-bands, a second CQI (e.g., corresponding to a second inter-band interference level) associated with a second sub-band from the set of sub-bands, and a third CQI (e.g., corresponding to a third inter-band interference level) associated with a third sub-band from the set of sub-bands.

Additionally, or alternatively, the report 230 may include (e.g., via a reportQuantity of cri-RI-LI-PMI-CQI-interf) an indication of the first CQI associated with measurement of the one or more downlink resources when the inter-band interference 220 is not present and an indication of a value of the inter-band interference 220 (e.g., measured inter-band interference). Additionally, or alternatively, the report 230 may include (e.g., via a reportQuantity of cri-RI-LI-PMI-CQI-delta) the indication of the first CQI associated with measurement of the one or more downlink resources when the inter-band interference 220 is not present and an indication of a differential value of the inter-band interference 220 relative to a reference value. In such cases, the UE 115-a may transmit the report based on the differential value (i.e., delta) being greater than a threshold differential value. Additionally, or alternatively, the reference value may be pre-configured at the UE 115-a, may be indicated to the UE 115-a (e.g., by the network entity 105-a), or both. For example, the reference value may be based on a measurement resource associated with a latest report 230 (e.g., inter-band interference report) transmitted by the UE 115-a prior to a current report 230). In some cases, the UE 115-a may report the differential value per sub-band (e.g., considering the transmission leakage being non-uniform in the frequency band 215-a).

In some cases, the UE 115-a may transmit the report 230 based on (e.g., when) one or more uplink messages 210 being scheduled during one or more uplink resources (e.g., measurement symbol) in the frequency band 215-b that at least partially overlap (e.g., in a time domain) with the one or more downlink resources in the frequency band 215-a. That is, the inter-band interference in the one or more downlink resources may be due to (e.g., based on) the one or more uplink messages 210 being transmitted via the one or more uplink resources that at least partially overlap with the one or more downlink resources, such that no inter-band interference 220 may be present when no uplink messages 210 are scheduled during the one or more uplink resources. Thus, the UE 115-a may refrain from transmitting the report 230 (e.g., drop CQI reporting) when no uplink messages 210 (e.g., uplink transmissions) are scheduled during the one or more uplink resources in the frequency band 215-b that at least partially overlap with the one or more downlink resources in the frequency band 215-a (e.g., when no uplink grant is received for the one or more uplink resources).

In some other cases, the UE 115-a may receive, via the control message 225 (e.g., or via an additional control message 225), an indication of the one or more uplink resources (e.g., configured grant (CG)-physical uplink control channel (PUSCH) or periodic sounding reference signal (SRS)) in the frequency band 215-b (e.g., C band, aggressor band), where the one or more uplink resources are associated with the one or more downlink resources (e.g., interference resources) in the frequency band 215-a (e.g., A band, victim band) to ensure inter-band interference 220 is created (e.g., is present). In other words, the network entity 105-a may configure the UE 115-a with the one or more uplink resources for inter-band interference measurement to indicate for the UE 115-a to transmit one or more uplink messages 210 during the one or more uplink resources to create the inter-band interference 220 on the one or more downlink resources.

In some cases, the one or more uplink resources may be for CG-PUSCH or for SRS. In such cases, a CG configuration identifier or an SRS resource identifier may be associated with a CSI report configuration identifier corresponding to the report 230 to indicate to the UE 115-a that the UE 115-a is to simultaneously transmit a corresponding CG or SRS, respectively, (e.g., via the one or more uplink resources) (e.g., at a same time) and measure the one or more downlink resources (e.g., transmission of the CG-PUSCH or SRS happens at a same time as measurement of the one or more downlink resources), that the UE 115-a is to transmit the corresponding CG-PUSCH or SRS via the frequency band 215-b (e.g., to ensure a second harmonic relationship between the corresponding CG-PUSCH or SRS and reception of the inter-band interference 220), or both. In some cases, alignment of transmission of the CG-PUSCH or SRS and measurement of the inter-band interference may be based on aligned periodicities, based on pre-configuration of the UE 115-a (e.g., pre-configuration of when transmission and reception is to occur based on occasions of uplink and downlink resources), or both. Additionally, or alternatively, in a case of CG-PUSCH, the network entity 105-a may indicate (e.g., explicitly or via the association with the CSI report configuration identifier) to the UE 115-a that the UE 115-a is not to skip the CG-PUSCH corresponding to the CG configuration identifier. Additionally, or alternatively, the UE 115-a may drop the CG-PUSCH or SRS if one or more other transmissions via at least a subset of the one or more uplink resources (e.g., RBs) overlap in time with the one or more downlink resources (e.g., the inter-band interference 220 happens without configuration by the network entity 105-a).

In some examples, when the UE 115-a does not have data available for transmission via the one or more uplink resources, the UE 115-a may transmit, via the one or more uplink resources, a padding-buffer status report (BSR), a padding-power headroom report (PHR), a pre-configured payload (e.g., a payload known by both the UE 115-a and the network entity 105-b, which may be used for machine learning (L) at the network entity 105-a), or any combination thereof.

Additionally, or alternatively, the report 230 may include information associated with the inter-band interference 220. For example, rather than reporting the one or more CQIs (e.g., interference metrics), the UE may report the information associated with the inter-band interference 220 (e.g., separately or via assistance information), resulting in decreased overhead (e.g., as compared to CQI reporting). In such cases, the information associated with the inter-band interference 220 may include an indication (e.g., a 1-bit indication) of whether the inter-band interference 220 is based on a second harmonic relationship between the frequency band 215-a and the frequency band 215-b or not (e.g., whether there is a second harmonics impact on the one or more downlink resources), whether the inter-band interference 220 exceeds a threshold interference level or not, or both. For example, a first bit value may indicate the inter-band interference 220 is based on a second harmonic relationship between the frequency band 215-a and the frequency band 215-b, the inter-band interference 220 exceeds the threshold interference level, or both, and a second bit value may indicate the inter-band interference 220 is not based on a second harmonic relationship between the frequency band 215-a and the frequency band 215-b, the inter-band interference 220 does not exceed the threshold interference level, or both. In some cases, the indication may be multiple bits (e.g., N bits), where each bit is associated with a downlink resource of the one or more downlink resources (e.g., based on non-uniform leakage). That is, each bit may indicate information associated with the inter-band interference 220 for a respective downlink resource (e.g., or N downlink resources) of the one or more downlink resources.

Additionally, or alternatively, the information associated with the inter-band interference 220 may include an indication of whether to exclude at least a subset of the one or more downlink resources measured for inter-band interference 220 based on inter-band interference 220 associated with the subset of the one or more downlink resources exceeding the threshold interference level.

Additionally, or alternatively, the UE 115-a may transmit, to the network entity 105-a, a capability message indicating one or more capabilities of the UE 115-a to support the techniques described herein. For example, the capability message may indicate whether the UE 115-a supports inter-band interference RSSI-based measurement and reporting, whether the UE 115-a supports inter-band interference CQI-based measurement and reporting, or both.

Though described in the context of RSSI-based inter-band interference measurement and reporting and CQI-based inter-band interference measurement and reporting, this is not to be regarded as a limitation of the present disclosure. In this regard, the techniques described herein may be applicable to any type of inter-band interference measurement and reporting. For example, techniques described in the context of CQI-based inter-band interference measurement and reporting may additionally, or alternatively, be applicable to RSSI-based inter-band interference measurement and reporting (e.g., and/or visa-versa). Additionally, or alternatively, techniques described in the context of CQI-based inter-band interference measurement and reporting, techniques described in the context of RSSI-based inter-band interference measurement and reporting, or both, may be considered with regards to one or more other metrics, such as SINR, among other examples.

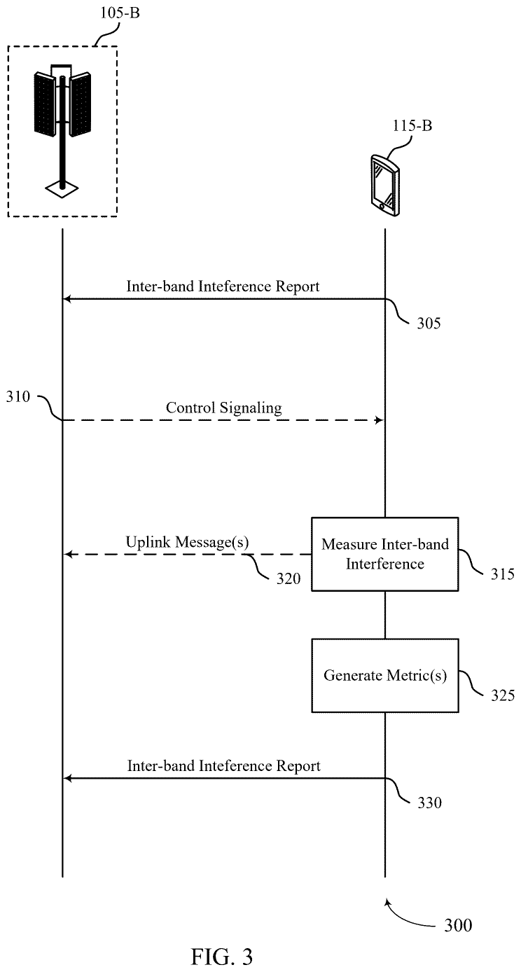

FIG. 3 shows an example of a process flow 300 that supports techniques for inter-band interference measurement and reporting in accordance with one or more aspects of the present disclosure. In some cases, the process flow 300 may implement or be implemented by aspects of the wireless communications system 100, the wireless communications system 200, or both. For example, the process flow 300 may include one or more UEs 115 (e.g., a UE 115-b) and one or more network entities 105 (e.g., a network entity 105-b), which may be examples of the corresponding devices as described herein. In the following description of the process flow 300, the operations between the UE 115-b and the network entity 105-b may be communicated in a different order than the example order shown, or the operations performed by the UE 115-b and the network entity 105-b may be performed in different orders or at different times. Some operations may also be omitted from the process flow 300, and other operations may be added to the process flow 300. In some cases, the UE 115-b may simultaneously transmit one or more uplink messages and receive one or more downlink messages in accordance with a FDD communication scheme, in accordance with inter-band CA, in accordance with a DC communication scheme, or any combination thereof.

In some cases, at 305, the UE 115-b may transmit (e.g., send) a capability message indicative of whether the UE 115-b supports reporting of inter-band interference. In some cases, the capability message may be indicative of whether the UE 115-b supports RSSI-based inter-band interference, CQI-based inter-band interference, or both.

In some cases, at 310, the UE 115-b may receive, from the network entity 105-b, control signaling indicative of one or more resources associated with measurement, in a first frequency band associated with one or more downlink communications received by the UE 115-b, of inter-band interference. In some cases, the one or more downlink resources may be referred to as interference measurement resources, or the like thereof.

In some cases, the control signaling may indicate one or more resource identifiers associated with the one or more resources associated with an inter-band interference resource set, an index associated with a first resource of the one or more resources, a quantity of the one or more resources, a symbol associated with the first resource of the one or more resources within a slot, a quantity of symbols associated with the one or more resources within the slot, a periodicity and a slot offset associated with the one or more resources, an SCS associated with the one or more resources, QCL information, with qcl-Type set to ‘typeD,’ associated with the one or more resources, or any combination thereof.

In some cases, the one or more resources may include a set of aperiodic resources. In such cases, the control signaling may be DCI signaling in an aperiodic inter-band interference resource set configuration. In some cases, the control signaling may indicate configuration information associated with a report to be transmitted by the UE 115-b.

In some cases, the control signaling may schedule one or more uplink messages (e.g., uplink transmissions) via one or more uplink resources associated with measurement of the inter-band interference.

At 315, the UE 115-b may measure the inter-band interference between one or more uplink communications transmitted by the UE 115-b and the one or more downlink communications received by the UE 115-b. In such cases, the inter-band interference may be based on a first frequency (e.g., 7 GHz) of the first frequency band associated with the one or more downlink communications being double (e.g., twice) a second frequency (e.g., 3.5 GHz) of a second frequency band associated with the one or more uplink communications, resulting in a second harmonic relationship between the first frequency and the second frequency.

In some cases, the measurement of the inter-band interference may be via one or more resources in the first frequency band associated with the downlink communications, and the one or more metrics may include a respective metric associated with each resource of the one or more resources.

Additionally, or alternatively, measurement of the inter-band interference may be based on transmission, via one or more resources in the second frequency band, of the one or more uplink communications in accordance with one or more uplink transmission powers, and the one or more metrics may include a respective metric associated with each uplink transmission power of the one or more uplink transmission powers.

Additionally, or alternatively, the measurement of the inter-band interference may be via one or more resources in the first frequency band associated with the one or more downlink communications, and the one or more metrics may include a first metric associated with a first sub-configuration of the one or more resources and a second metric associated with a second sub-configuration of the one or more resources.

In some cases, the UE 115-b may be associated with multiple beam pairs, such that measurement of the inter-band interference is associated with a subset of the multiple beam pairs. Additionally, or alternatively, the measurement of the inter-band interference may be via one or more resources in the first frequency band associated with the one or more downlink communications, where each resource of the one or more resources is associated with a beam pair from the multiple beam pairs.

In some cases, at 320, the UE 115-b may transmit the one or more uplink messages via the one or more uplink resources, where the one or more uplink resources correspond to the one or more resources associated with measurement of the inter-band interference. In some cases, the one or more uplink messages may include a BSR, a PHR, a configured payload, or any combination thereof, based on no uplink data being scheduled via the one or more uplink resources.

At 325, the UE 115-b may generate one or more metrics associated with the inter-band interference based on the measurement of the inter-band interference.

At 330, the UE 115-b may transmit, to the network entity 105-b, the report (e.g., a CSI report, an inter-band interference report) that includes an indication of the one or more metrics associated with the inter-band interference.

In some cases, the transmission of the report may be in accordance with a slot offset between a first slot associated with the DCI signaling that triggers the set of aperiodic resources and a second slot in which the set of aperiodic resources are measured. Additionally, or alternatively, the transmission of the report may be based on an occurrence of one or more trigger events, where the one or more trigger events include the inter-band interference satisfying a threshold interference, a change in one or more beam pairs, a change in the inter-band interference satisfying a threshold interference change, or any combination thereof. In some cases, the transmission of the report may be based on transmission of the one or more uplink messages.

In some cases, the one or more metrics may include a first RSSI associated with an absence of the inter-band interference and a second RSSI associated with a presence of the inter-band interference. In some examples, measurement of the inter-band interference may be performed autonomously by the UE 115-b, where the transmission of the report is via an uplink grant, a MAC-CE message, one or more periodic uplink resources, or any combination thereof, based on the measurement of the inter-band interference being performed autonomously by the UE 115-b.

In some cases, the report may be indicative of the inter-band interference associated with the multiple beam pairs based on inputting the inter-band interference associated with the subset of the multiple beam pairs into an ML model. Additionally, or alternatively, the one or more metrics may include a respective metric associated with each beam pair from the multiple beam pairs. Additionally, or alternatively, the one or more metrics may include an indication of a first inter-band interference associated with a first beam pair of the multiple beam pairs and an indication of a respective differential value from the first inter-band interference associated with each other beam pair of the multiple beam pairs. In such cases, the first inter-band interference is a highest inter-band interference from among the multiple beam pairs.

In some cases, the one or more metrics may include an indication of a first inter-band interference associated with a first resource of the one or more resources and an indication of a respective differential value from the first inter-band interference associated with each other resource of the one or more resources. In such cases, the first inter-band interference may be a highest inter-band interference from among the one or more resources.

In some examples, the transmitting of the report may include transmitting a NACK message based on failure to receive the downlink communications, where the NACK message includes the indication of the one or more metrics associated with the inter-band interference based on failure of the UE 115-b to receive the downlink communications being based on the inter-band interference.

In some cases, the one or more metrics may include a first CQI associated with an absence of the inter-band interference and a second CQI associated with a presence of the inter-band interference. Additionally, or alternatively, the first CQI may be associated with a first sub-configuration of the UE 115-b and the second CQI may be associated with a second sub-configuration of the UE 115-a. Additionally, or alternatively, the first CQI may be associated with a first set of frequency resources, a first set of sub-bands, a first set of RBs, or any combination thereof, and the second CQI may be associated with a second set of frequency resources, a second set of sub-bands, a second set of RBs, or any combination thereof.

In some cases, the one or more metrics may include a report quantity indicative of the first CQI associated with an absence of the inter-band interference and a value of the inter-band interference.

In some cases, the report may include an indication of whether the inter-band interference satisfies one or more interference thresholds, an indication to exclude one or more RBs, a range of RBs, or both, associated with the inter-band interference satisfying the one or more interference thresholds, or both.

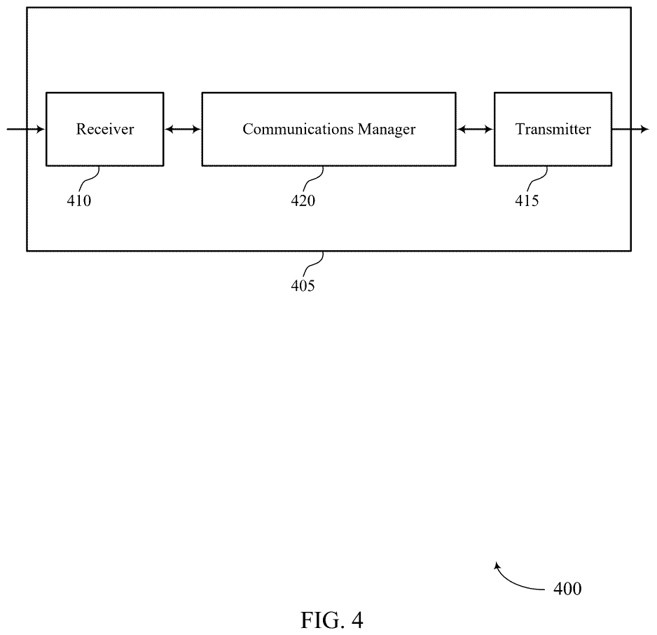

FIG. 4 shows a block diagram 400 of a device 405 that supports techniques for inter-band interference measurement and reporting in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for inter-band interference measurement and reporting). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for inter-band interference measurement and reporting). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for inter-band interference measurement and reporting as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for measuring inter-band interference between one or more uplink communications transmitted by the UE and one or more downlink communications received by the UE, where the inter-band interference is based on a first frequency of a first frequency band associated with the one or more downlink communications being double a second frequency of a second frequency band associated with the one or more uplink communications. The communications manager 420 is capable of, configured to, or operable to support a means for generating one or more metrics associated with the inter-band interference based on the measurement of the inter-band interference. The communications manager 420 is capable of, configured to, or operable to support a means for sending a report that includes an indication of the one or more metrics associated with the inter-band interference.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for inter-band interference measurement and reporting, which may result in reduced processing, reduced power consumption, and more efficient utilization of communication resources, among other advantages.

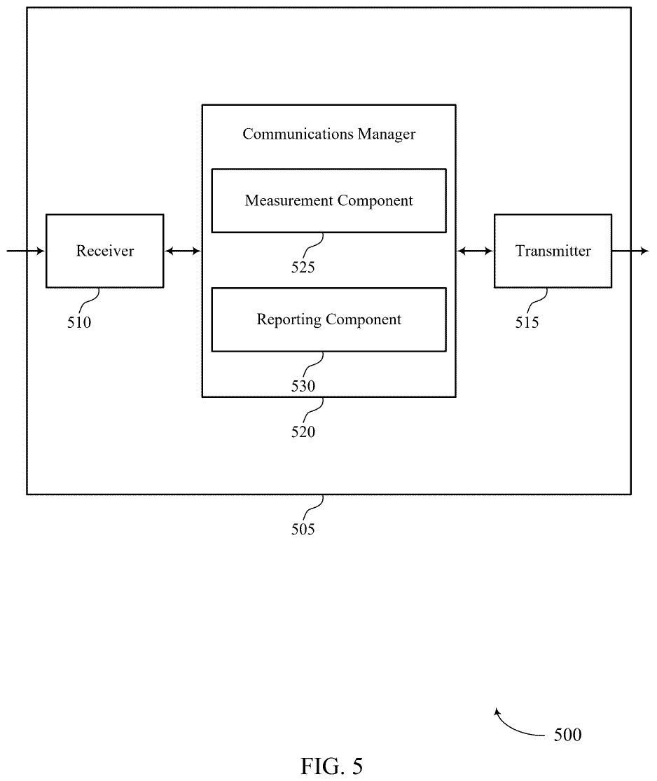

FIG. 5 shows a block diagram 500 of a device 505 that supports techniques for inter-band interference measurement and reporting in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for inter-band interference measurement and reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for inter-band interference measurement and reporting). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for inter-band interference measurement and reporting as described herein. For example, the communications manager 520 may include a measurement component 525 a reporting component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The measurement component 525 is capable of, configured to, or operable to support a means for measuring inter-band interference between one or more uplink communications transmitted by the UE and one or more downlink communications received by the UE, where the inter-band interference is based on a first frequency of the first frequency band associated with the one or more downlink communications being double a second frequency of a second frequency band associated with the one or more uplink communications. The measurement component 525 is capable of, configured to, or operable to support a means for generating one or more metrics associated with the inter-band interference based on the measurement of the inter-band interference. The reporting component 530 is capable of, configured to, or operable to support a means for sending a report that includes an indication of the one or more metrics associated with the inter-band interference.

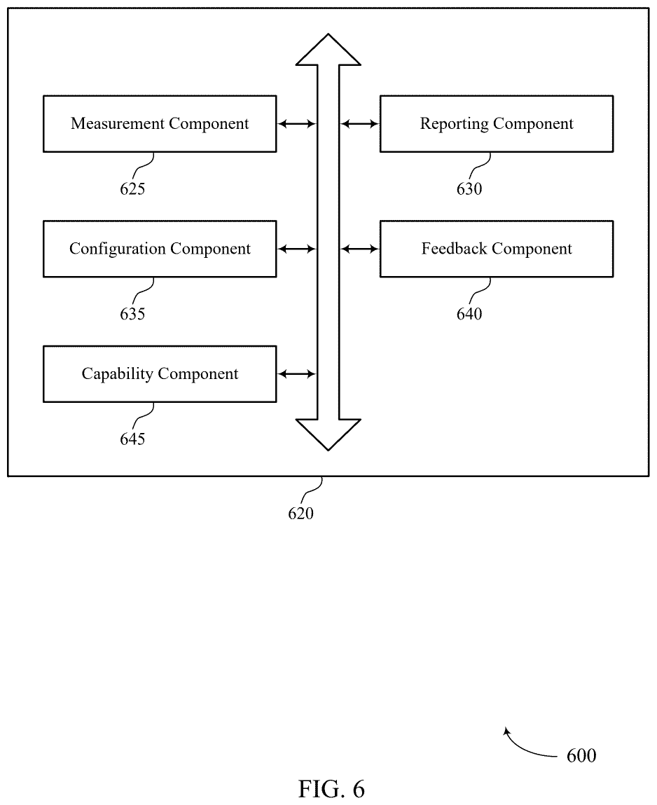

FIG. 6 shows a block diagram 600 of a communications manager 620 that supports techniques for inter-band interference measurement and reporting in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for inter-band interference measurement and reporting as described herein. For example, the communications manager 620 may include a measurement component 625, a reporting component 630, a configuration component 635, a feedback component 640, a capability component 645, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The measurement component 625 is capable of, configured to, or operable to support a means for measuring inter-band interference between one or more uplink communications transmitted by the UE and one or more downlink communications received by the UE, where the inter-band interference is based on a first frequency of a first frequency band associated with the one or more downlink communications being double a second frequency of a second frequency band associated with the one or more uplink communications. The measurement component 625 is capable of, configured to, or operable to support a means for generating one or more metrics associated with the inter-band interference based on the measurement of the inter-band interference. The reporting component 630 is capable of, configured to, or operable to support a means for sending a report that includes an indication of the one or more metrics associated with the inter-band interference.

In some examples, the configuration component 635 is capable of, configured to, or operable to support a means for receiving control signaling indicative of one or more resources associated with measurement, in the first frequency band associated with the one or more downlink communications, of the inter-band interference, where measurement of the inter-band interference is based on reception of the control signaling.

In some examples, the one or more resources associated with the the measurement of the inter-band interference are periodic, semi-persistent, or aperiodic.

In some examples, the control signaling indicates one or more resource identifiers associated with the one or more resources associated with an inter-band interference resource set, an index associated with a first resource of the one or more resources, a quantity of the one or more resources, a symbol associated with the first resource of the one or more resources within a slot, a quantity of symbols associated with the one or more resources within the slot, a periodicity and a slot offset associated with the one or more resources, a subcarrier spacing associated with the one or more resources, quasi-co-location information, with qcl-Type set to ‘typeD,’ associated with the one or more resources, or any combination thereof.

In some examples, the quasi-co-location information includes a list of transmission configuration indicator states. In some examples, the measurement of each of the one or more resources is in accordance with a transmission configuration indicator state from the list of transmission configuration indicator states.

In some examples, the measurement of the one or more resources is in accordance with a transmission configuration indicator state associated with one of a last received downlink shared channel prior to the one or more resources and a latest monitored control resource set prior to the one or more resources based on the quasi-co-location information not being configured and based on unifiedTCI-StateType not being configured.

In some examples, the measurement of the one or more resources is in accordance with a transmission configuration indicator state associated with an indicated downlink only transmission configuration indicator state, an indicated joint transmission configuration indicator state, or both, prior to the one or more resources based on the quasi-co-location information not being configured and based on unifiedTCI-StateType being configured.

In some examples, the one or more resources are periodic resources. In some examples, each resource of the one or more resources is associated with a respective transmission configuration indicator state configured per resource of the one or more resources in accordance with one or more respective parameters. In some examples, the measurement of the one or more resources is in accordance with the respective transmission configuration indicator states.

In some examples, the control signaling includes an activation or deactivation medium access control-control element message. In some examples, the activation or deactivation medium access control-control element message includes one or more fields indictive of one or more transmission configuration indicator states associated with the one or more resources. In some examples, the measurement of the one or more resources is in accordance with the one or more transmission configuration indicator states.

In some examples, the measurement of the inter-band interference is based on transmission of one or more uplink messages via one or more second resources in the second frequency band associated with the one or more uplink communications. In some examples, the one or more second resources at least partially overlap the one or more resources. In some examples, the one or more uplink messages includes one or more sounding reference signals, one or more demodulation reference signals, one or more uplink reference signals, or any combination thereof.

In some examples, the one or more uplink messages are transmitted in accordance with an uplink transmission power. In some examples, the uplink transmission power is a default transmission power, is based on an indication from a network entity, is based on a range of uplink transmission powers, or any combination thereof.

In some examples, the control signaling includes a CSI-ResourceConfig information element. In some examples, the CSI-ResourceConfig information element is indicative of an interference measurement resource set list including the one or more resources.

In some examples, the control signaling includes a CSI-ReportConfig information element. In some examples, the CSI-ReportConfig information element includes an indication of an identifier of a channel measurement resource configuration associated with the one or more resources.

In some examples, the control signaling includes a CSI-IM information element indicative of the one or more resources.

In some examples, the one or more resources include a set of aperiodic resources. In some examples, the control signaling is downlink control information signaling in an aperiodic inter-band interference resource set configuration. In some examples, the transmission of the report is in accordance with a slot offset between a first slot associated with the downlink control information signaling that triggers the set of aperiodic resources and a second slot in which the set of aperiodic resources are measured.

In some examples, the configuration component 635 is capable of, configured to, or operable to support a means for receiving control signaling indicative of configuration information associated with the report, where the transmission of the report is based on reception of the control signaling.

In some examples, the control signaling is indicative of a sub-band size, a quantity of sub-bands, or both. In some examples, the one or more metrics include one or more respective metrics associated with each sub-band among the quantity of sub-bands.

In some examples, the control signaling indicates that the report is a wideband report.

In some examples, the report is aperiodic, periodic, or semi-persistent.

In some examples, the control signaling includes a CSI-reportConfig information element. In some examples, the CSI-reportConfig information element includes a reportQuantity information element. In some examples, the reportQuantity information element indicates the report is associated with inter-band interference reporting.

In some examples, the transmission of the report is based on an occurrence of one or more trigger events.

In some examples, the one or more trigger events include the inter-band interference satisfying a threshold interference, a change in one or more beam pairs, a change in the inter-band interference satisfying a threshold interference change, or any combination thereof.

In some examples, the configuration component 635 is capable of, configured to, or operable to support a means for receiving control signaling indicative of a set of trigger events including at least the one or more trigger events, where the transmission of the report is based on reception of the control signaling.

In some examples, the transmission of the report is via uplink control information (UCI), a medium access control-control element (MAC-CE) message, or both.

In some examples, the measurement of the inter-band interference is via one or more resources in the first frequency band associated with the one or more downlink communications. In some examples, the one or more metrics include a respective metric associated with each resource of the one or more resources.

In some examples, the measurement of the inter-band interference is based on transmission, via one or more resources in the second frequency band, of the one or more uplink communications in accordance with one or more uplink transmission powers. In some examples, the one or more metrics include a respective metric associated with each uplink transmission power of the one or more uplink transmission powers.

In some examples, the capability component 645 is capable of, configured to, or operable to support a means for transmitting assistance information indicative of the one or more uplink transmission powers based on the measurement of the inter-band interference is via the one or more resources in accordance with one or more uplink transmission powers.

In some examples, the measurement of the inter-band interference is via one or more resources in the first frequency band associated with the one or more downlink communications. In some examples, the one or more metrics include a first metric associated with a first sub-configuration of the one or more resources and a second metric associated with a second sub-configuration of the one or more resources.

In some examples, the report is associated with a priority value from a set of priority values. In some examples, the priority value is zero, one, or a value different than zero or one associated with multiplexing one or more channel state information reports.

In some examples, the transmission of the report is based on transmission of one or more uplink messages via one or more uplink resources. In some examples, the one or more uplink resources correspond to one or more downlink resources associated with the measurement of the inter-band interference.

In some examples, the one or more metrics include a first received signal strength indicator associated with an absence of the inter-band interference and include a second received signal strength indicator associated with a presence of the inter-band interference.

In some examples, the measurement of the inter-band interference is performed autonomously by the UE. In some examples, the transmission of the report is via an uplink grant, a medium access control-control element (MAC-CE) message, one or more periodic uplink resources, or any combination thereof, based on the measurement of the inter-band interference being performed autonomously by the UE.

In some examples, the UE is associated with a set of multiple beam pairs. In some examples, the measurement of the inter-band interference is associated with a subset of the set of multiple beam pairs. In some examples, the report is indicative of the inter-band interference associated with the set of multiple beam pairs based on inputting the inter-band interference associated with the subset of the set of multiple beam pairs into a machine learning model.

In some examples, the configuration component 635 is capable of, configured to, or operable to support a means for receiving control signaling indicative of configuration information associated with the report, where the configuration information is indicative of a quantity measurement resources to be reported by the UE, and where the transmission of the report is based on reception of the control signaling.

In some examples, the measurement of the inter-band interference is via one or more resources in the first frequency band associated with the one or more downlink communications. In some examples, each resource of the one or more resources is associated with a beam pair from a set of multiple beam pairs. In some examples, the one or more metrics include a respective metric associated with each beam pair from the set of multiple beam pairs.

In some examples, the one or more metrics include an indication of a first inter-band interference associated with a first beam pair of the set of multiple beam pairs and include an indication of a respective differential from the first inter-band interference associated with each other beam pair of the set of multiple beam pairs. In some examples, the first inter-band interference is a highest inter-band interference from among the set of multiple beam pairs.

In some examples, the measurement of the inter-band interference is via one or more resources in the first frequency band associated with the one or more downlink communications. In some examples, the one or more metrics include an indication of a first inter-band interference associated with a first resource of the one or more resources and include an indication of a respective differential from the first inter-band interference associated with each other resource of the one or more resources. In some examples, the first inter-band interference is a highest inter-band interference from among the one or more resources.

In some examples, to support transmitting the report, the feedback component 640 is capable of, configured to, or operable to support a means for transmitting a NACK message based on failure to receive the one or more downlink communications, where the NACK message includes the indication of the one or more metrics associated with the inter-band interference based at in part on failure of the UE to receive the one or more downlink communications being based on the inter-band interference.

In some examples, the configuration component 635 is capable of, configured to, or operable to support a means for receiving control signaling indicative of one or more interference measurement resources associated with measurement, in the first frequency band associated with the one or more downlink communications, of the inter-band interference, where the measurement of the inter-band interference is based on reception of the control signaling.

In some examples, the one or more metrics include a first channel quality indicator associated with an absence of the inter-band interference and include a second channel quality indicator associated with a presence of the inter-band interference.

In some examples, the one or more metrics include a first channel quality indicator associated with a first sub-configuration of the UE and include a second channel quality indicator associated with a second sub-configuration of the UE.

In some examples, the one or more metrics include a first channel quality indicator associated with a first set of frequency resources, a first set of sub-bands, a first set of resource blocks, or any combination thereof. In some examples, a second channel quality indicator associated with a second set of frequency resources, a second set of sub-bands, a second set of resource blocks, or any combination thereof.

In some examples, the one or more metrics include a report quantity indicative of a first channel quality indicator associated with an absence of the inter-band interference and a value of the inter-band interference.

In some examples, the one or more metrics include the report quantity and. In some examples, the value of the inter-band interference includes a differential value relative to a reference value. In some examples, the transmission of the report is based on the differential value satisfying a threshold differential value.

In some examples, the configuration component 635 is capable of, configured to, or operable to support a means for receiving control signaling scheduling one or more uplink transmissions via one or more uplink resources associated with the measurement of the inter-band interference, and where the transmission of the report is based on the one or more uplink transmissions being scheduled on the one or more uplink resources.

In some examples, the measurement component 625 is capable of, configured to, or operable to support a means for transmitting one or more of a buffer status report, a power headroom report, a configured payload, or any combination thereof, based on no uplink data being scheduled via one or more uplink resource associated with the measurement of the inter-band interference.

In some examples, one or more configured grant configuration identifiers, one or more sounding reference signal resource identifiers, or both, are associated with the report. In some examples, the one or more configured grant configuration identifiers, the one or more sounding reference signal resource identifiers, or both, are associated with one or more uplink resource associated with the measurement of the inter-band interference.

In some examples, configured grant skipping is disabled for one or more configured grants associated with the one or more configured grant configuration identifiers.

In some examples, the report includes an indication of whether the inter-band interference satisfies one or more interference thresholds, an indication to exclude one or more resource blocks, a range of resource blocks, or both, associated with the inter-band interference satisfying the one or more interference thresholds, or both.

In some examples, the report includes the indication of whether the inter-band interference satisfies the one or more interference thresholds per resource block, per resource block level, or both.

In some examples, the capability component 645 is capable of, configured to, or operable to support a means for transmitting a capability message indicative of whether the UE supports reporting of the inter-band interference, where the measurement of the inter-band interference is based on transmission of the capability message.

In some examples, the capability message is indicative of whether the UE supports receive signal strength indicator-based inter-band interference reporting, channel quality indicator-based inter-band interference reporting, or both.

In some examples, the capability message is indicative of whether the UE supports each feature of one or more first features associated with receive signal strength indicator-based inter-band interference reporting, whether the UE supports each feature of one or more second features associated with channel quality indicator-based inter-band interference reporting, or both.

In some examples, the first frequency is 7 gigahertz. In some examples, the second frequency is 3.5 gigahertz.

In some examples, the inter-band interference is due to second harmonics between the first frequency band and the second frequency band in accordance with the first frequency of the first frequency band being double the second frequency of the second frequency band.

In some examples, the inter-band interference is associated with inter-band carrier aggregation, inter-band dual connectivity, or both.

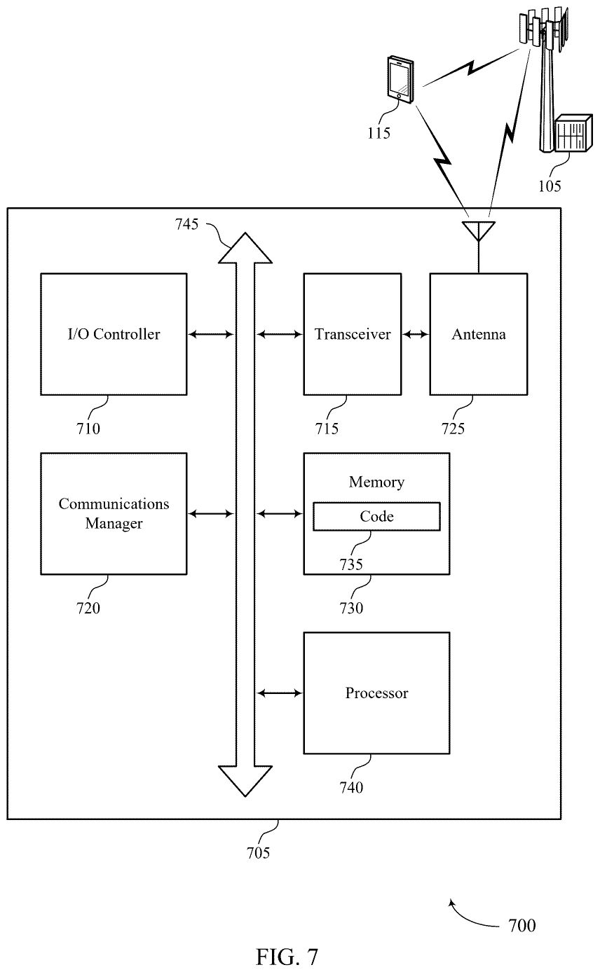

FIG. 7 shows a diagram of a system 700 including a device 705 that supports techniques for inter-band interference measurement and reporting in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for inter-band interference measurement and reporting). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for measuring inter-band interference between one or more uplink communications transmitted by the UE and one or more downlink communications received by the UE, where the inter-band interference is based on a first frequency of a first frequency band associated with the one or more downlink communications being double a second frequency of a second frequency band associated with the one or more uplink communications. The communications manager 720 is capable of, configured to, or operable to support a means for transmitting a report that includes an indication of the one or more metrics associated with the inter-band interference.

By including or configuring the communications manager 720 in accordance with examples as described herein, the device 705 may support techniques for inter-band interference measurement and reporting, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for inter-band interference measurement and reporting as described herein, or the at least one processor 740 and the at least one memory 730 may be otherwise configured to, individually or collectively, perform or support such operations.

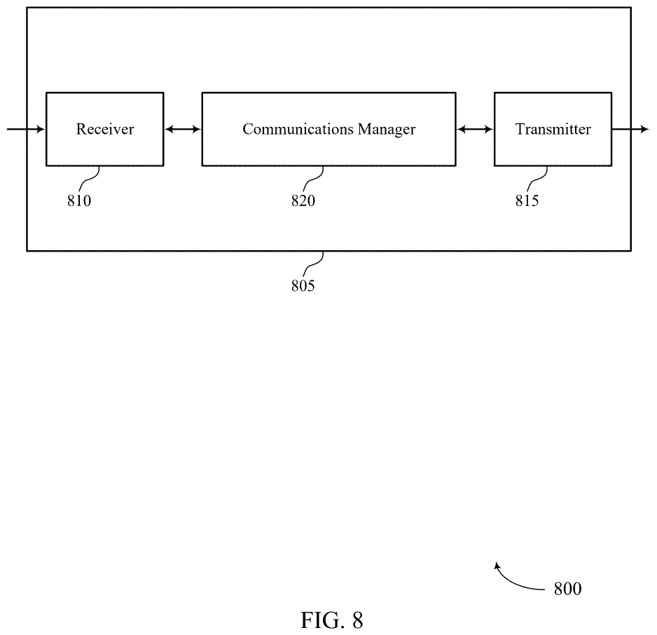

FIG. 8 shows a block diagram 800 of a device 805 that supports techniques for inter-band interference measurement and reporting in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for inter-band interference measurement and reporting as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for outputting control signaling indicative of one or more resources associated with measurement of inter-band interference between one or more uplink communications received by the network entity and one or more downlink communications transmitted by the network entity, where the inter-band interference is based on a first frequency of a first frequency band associated with the one or more downlink communications being double a second frequency of a second frequency band associated with the one or more uplink communications. The communications manager 820 is capable of, configured to, or operable to support a means for obtaining a report indicative of the inter-band interference, where the report includes an indication of one or more metrics associated with the inter-band interference.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for inter-band interference measurement and reporting, which may result in reduced processing, reduced power consumption, and more efficient utilization of communication resources, among other advantages.

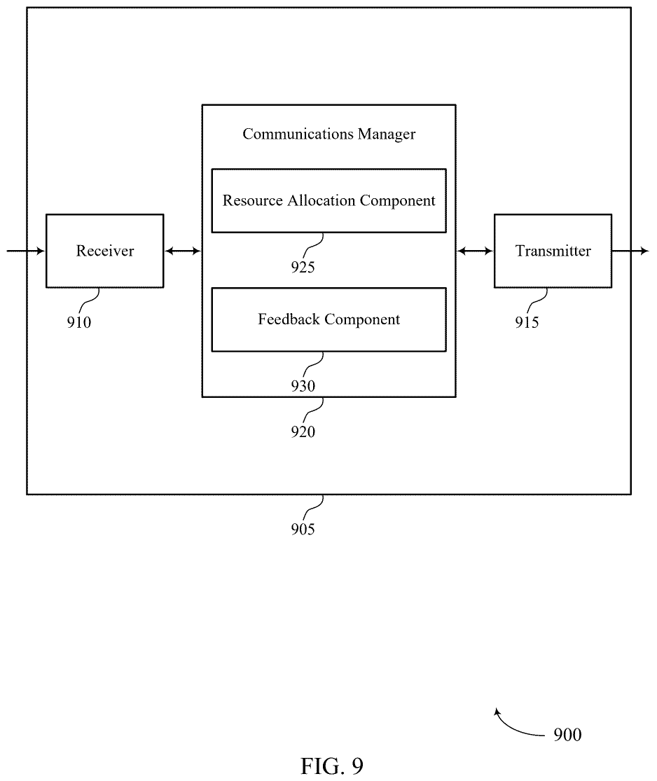

FIG. 9 shows a block diagram 900 of a device 905 that supports techniques for inter-band interference measurement and reporting in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for inter-band interference measurement and reporting as described herein. For example, the communications manager 920 may include a resource allocation component 925 a feedback component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The resource allocation component 925 is capable of, configured to, or operable to support a means for outputting control signaling indicative of one or more resources associated with measurement of inter-band interference between one or more uplink communications received by the network entity and one or more downlink communications transmitted by the network entity, where the inter-band interference is based on a first frequency of a first frequency band associated with the one or more downlink communications being double a second frequency of a second frequency band associated with the one or more uplink communications. The feedback component 930 is capable of, configured to, or operable to support a means for obtaining a report indicative of the inter-band interference, where the report includes an indication of one or more metrics associated with the inter-band interference.

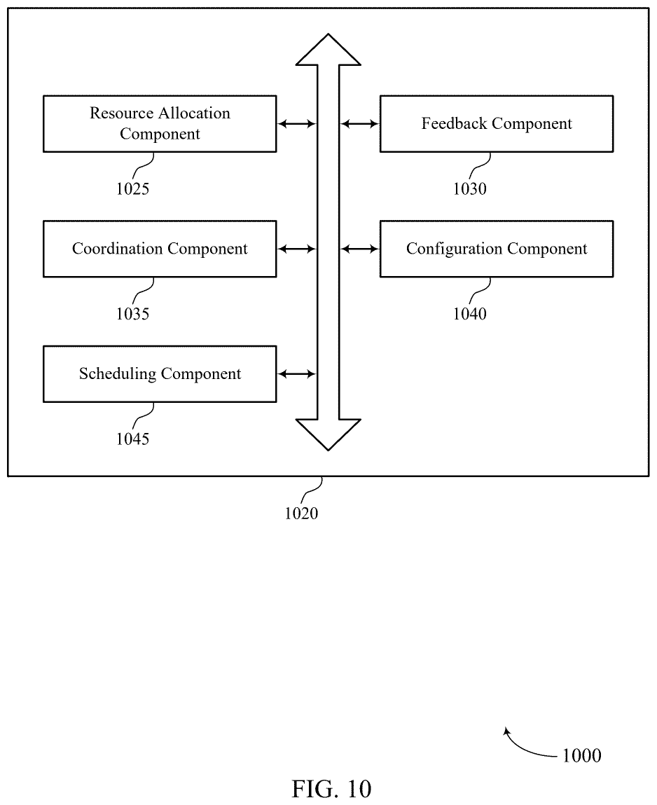

FIG. 10 shows a block diagram 1000 of a communications manager 1020 that supports techniques for inter-band interference measurement and reporting in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for inter-band interference measurement and reporting as described herein. For example, the communications manager 1020 may include a resource allocation component 1025, a feedback component 1030, a coordination component 1035, a configuration component 1040, a scheduling component 1045, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The resource allocation component 1025 is capable of, configured to, or operable to support a means for outputting control signaling indicative of one or more resources associated with measurement of inter-band interference between one or more uplink communications received by the network entity and one or more downlink communications transmitted by the network entity, where the inter-band interference is based on a first frequency of a first frequency band associated with the one or more downlink communications being double a second frequency of a second frequency band associated with the one or more downlink communications. The feedback component 1030 is capable of, configured to, or operable to support a means for obtaining a report indicative of the inter-band interference based on the output of the control signaling, where the report includes an indication of one or more metrics associated with the inter-band interference.

In some examples, the coordination component 1035 is capable of, configured to, or operable to support a means for obtaining, from a second network entity, an indication of one or more second resources associated with measurement of inter-band interference between one or more second uplink communications received by the second network entity and one or more second downlink communications transmitted by the second network entity. In some examples, the coordination component 1035 is capable of, configured to, or operable to support a means for refraining from communicating via the one or more second resources based on reception of the indication.

In some examples, the one or more resources associated with the measurement of the inter-band interference are periodic, semi-persistent, or aperiodic.

In some examples, the control signaling indicates one or more resource identifiers associated with the one or more resources associated with an inter-band interference resource set, an index associated with a first resource of the one or more resources, a quantity of the one or more resources, a symbol associated with the first resource of the one or more resources within a slot, a quantity of symbols associated with the one or more resources within the slot, a periodicity and a slot offset associated with the one or more resources, a subcarrier spacing associated with the one or more resources, quasi-co-location information, with a quasi-co-location type set to ‘typeD,’ associated with the one or more resources, or any combination thereof.

In some examples, the quasi-co-location information includes a list of transmission configuration indicator states. In some examples, measurement of each of the one or more resources is in accordance with a transmission configuration indicator state from the list of transmission configuration indicator states.

In some examples, measurement of the one or more resources is in accordance with a transmission configuration indicator state associated with one of a last received downlink shared channel message prior to the one or more resources and a last monitored control resource set prior to the one or more resources based on the quasi-co-location information not being configured and based on unifiedTCI-StateType not being configured.

In some examples, measurement of the one or more resources is in accordance with a transmission configuration indicator state associated with an indicated downlink only transmission configuration indicator state, an indicated joint transmission configuration indicator state, or both, prior to the one or more resources based on the quasi-co-location information not being configured and based on unifiedTCI-StateType being configured.

In some examples, the one or more resources are periodic resources. In some examples, each resource of the one or more resources is associated with a respective transmission configuration indicator state configure per resource of the one or more resources in accordance with one or more respective parameters. In some examples, measurement of the one or more resources is in accordance with the respective transmission configuration indicator states.

In some examples, the control signaling includes an activation or deactivation medium access control-control element message. In some examples, the activation or deactivation medium access control-control element message includes one or more fields indictive of one or more transmission configuration indicator states associated with the one or more resources. In some examples, measurement of the one or more resources is in accordance with the one or more transmission configuration indicator states.

In some examples, reception of the report is based on reception of one or more uplink messages via one or more second resources in the second frequency band associated with the one or more uplink communications. In some examples, the one or more second resources at least partially overlap the one or more resources. In some examples, the one or more uplink messages includes one or more sounding reference signals, one or more demodulation reference signals, one or more uplink reference signals, or any combination thereof.

In some examples, the one or more uplink messages are received in accordance with an uplink transmission power. In some examples, the uplink transmission power is a default transmission power, is based on an indication from the network entity, is based on a range of uplink transmission powers, or any combination thereof.

In some examples, the control signaling includes a CSI-ResourceConfig information element. In some examples, the CSI-ResourceConfig information element is indicative of an interference measurement resource set list including the one or more resources.

In some examples, the control signaling includes a CSI-ReportConfig information element. In some examples, the CSI-ReportConfig information element includes an indication of an identifier of a channel measurement resource configuration associated with the one or more resources.

In some examples, the control signaling includes a CSI-IM information element indicative of the one or more resources.

In some examples, the one or more resources include a set of aperiodic resources. In some examples, the control signaling is downlink control information signaling in an aperiodic inter-band interference resource set configuration. In some examples, the obtaining of the report is in accordance with a slot offset between a first slot associated with the downlink control information signaling that triggers the set of aperiodic resources and a second slot in which the set of aperiodic resources are measured by a UE.

In some examples, the configuration component 1040 is capable of, configured to, or operable to support a means for outputting second control signaling indicative of configuration information associated with the report, where the obtaining of the report is based on the output of the second control signaling.

In some examples, the second control signaling is indicative of a sub-band size, a quantity of sub-bands, or both. In some examples, the one or more metrics include one or more respective metrics associated with each sub-band among the quantity of sub-bands.

In some examples, the second control signaling indicates that the report is a wideband report.

In some examples, the report is aperiodic, periodic, or semi-persistent.

In some examples, the second control signaling includes a CSI-reportConfig information element. In some examples, the CSI-reportConfig information element includes a reportQuantity information element. In some examples, the reportQuantity information element indicates the report is associated with inter-band interference reporting.

In some examples, the obtaining of the report is based on an occurrence of one or more trigger events.

In some examples, the one or more trigger events include the inter-band interference satisfying a threshold interference, a change in one or more beam pairs, a change in the inter-band interference satisfying a threshold interference change, or any combination thereof.

In some examples, the configuration component 1040 is capable of, configured to, or operable to support a means for outputting second control signaling indicative of a set of trigger events including at least the one or more trigger events, where the obtaining of the report is based on reception of the second control signaling.

In some examples, the obtaining of the report is via uplink control information (UCI), a medium access control-control element (MAC-CE) message, or both.

In some examples, measurement of the inter-band interference is via one or more resources in the first frequency band associated with the one or more downlink communications. In some examples, the one or more metrics include a respective metric associated with each resource of the one or more resources.

In some examples, the one or more metrics include a respective metric associated with each resource of the one or more resources associated with one or more uplink transmission powers.

In some examples, measurement of the inter-band interference is via one or more resources in the first frequency band associated with the one or more downlink communications. In some examples, the one or more metrics include a first metric associated with a first sub-configuration of the one or more resources and a second metric associated with a second sub-configuration of the one or more resources.

In some examples, the report is associated with a priority value from a set of priority values. In some examples, the priority value is zero, one, or a value different than zero or one associated with multiplexing one or more channel state information reports.

In some examples, the obtaining of the report is based on reception of one or more uplink messages via one or more uplink resources. In some examples, the one or more uplink resources correspond to one or more downlink resources associated with measurement of the inter-band interference.

In some examples, the one or more metrics include a first received signal strength indicator associated with an absence of the inter-band interference and include a second received signal strength indicator associated with a presence of the inter-band interference.

In some examples, the configuration component 1040 is capable of, configured to, or operable to support a means for outputting second control signaling indicative of configuration information associated with the report, where the configuration information is indicative of a quantity measurement resources to be reported by a UE, and where the obtaining of the report is based on transmission of the second control signaling.

In some examples, the network entity is associated with a set of multiple beam pairs. In some examples, the report is indicative of the inter-band interference associated with the set of multiple beam pairs.

In some examples, the one or more metrics include an indication of a first inter-band interference associated with a first beam pair of the set of multiple beam pairs and include an indication of a respective differential from the first inter-band interference associated with each other beam pair of the set of multiple beam pairs. In some examples, the first inter-band interference is a highest inter-band interference from among the set of multiple beam pairs.

In some examples, measurement of the inter-band interference is via one or more resources in the first frequency band associated with the one or more downlink communications. In some examples, the one or more metrics include an indication of a first inter-band interference associated with a first resource of the one or more resources and include an indication of a respective differential from the first inter-band interference associated with each other resource of the one or more resources. In some examples, the first inter-band interference is a highest inter-band interference from among the one or more resources.

In some examples, the feedback component 1030 is capable of, configured to, or operable to support a means for obtaining a NACK message indicating failure of a UE to receive the one or more downlink communications, where the NACK message includes the indication of the one or more metrics associated with the inter-band interference based at in part on failure of the UE to receive the one or more downlink communications being based on the inter-band interference.

In some examples, the one or more metrics include a first channel quality indicator associated with an absence of the inter-band interference and include a second channel quality indicator associated with the inter-band interference.

In some examples, the one or more metrics include a first channel quality indicator associated with a first sub-configuration of a UE and include a second channel quality indicator associated with a second sub-configuration of the UE.

In some examples, the one or more metrics include a first channel quality indicator associated with a first set of frequency resources, a first set of sub-bands, a first set of resource blocks, or any combination thereof. In some examples, a second channel quality indicator associated with a second set of frequency resources, a second set of sub-bands, a second set of resource blocks, or any combination thereof.

In some examples, the one or more metrics include a report quantity indicative of a first channel quality indicator associated with an absence of the inter-band interference and a value of the inter-band interference.

In some examples, the one or more metrics include the report quantity and. In some examples, the value of the inter-band interference includes a differential value relative to a reference value. In some examples, reception of the report is based on the differential value satisfying a threshold differential value.

In some examples, the scheduling component 1045 is capable of, configured to, or operable to support a means for outputting second control signaling scheduling one or more uplink transmissions via one or more uplink resources associated with measurement of the inter-band interference, and where the obtaining of the report is based on the one or more uplink transmissions being scheduled on the one or more uplink resources.

In some examples, the scheduling component 1045 is capable of, configured to, or operable to support a means for obtaining one or more of a buffer status report, a power headroom report, a configured payload, or any combination thereof, based on no uplink data being scheduled via one or more uplink resource associated with measurement of the inter-band interference.

In some examples, one or more configured grant configuration identifiers, one or more sounding reference signal resource identifiers, or both, are associated with the report. In some examples, the one or more configured grant configuration identifiers, the one or more sounding reference signal resource identifiers, or both, are associated with one or more uplink resource associated with measurement of the inter-band interference.

In some examples, configured grant skipping is disabled for one or more configured grants associated with the one or more configured grant configuration identifiers.

In some examples, the report includes an indication of whether the inter-band interference satisfies one or more interference thresholds, an indication to exclude one or more resource blocks, a range of resource blocks, or both, associated with the inter-band interference satisfying the one or more interference thresholds, or both.

In some examples, the report includes the indication of whether the inter-band interference satisfies the one or more interference thresholds per resource block, per resource block level, or both.

In some examples, the feedback component 1030 is capable of, configured to, or operable to support a means for obtaining a capability message indicative of whether a UE supports reporting of the inter-band interference, where the obtaining of the report is based on transmission of the capability message.

In some examples, the capability message is indicative of whether the UE supports receive signal strength indicator-based inter-band interference reporting, channel quality indicator-based inter-band interference reporting, or both.

In some examples, the capability message is indicative of whether the UE supports each feature of one or more first features associated with receive signal strength indicator-based inter-band interference reporting, whether the UE supports each feature of one or more second features associated with channel quality indicator-based inter-band interference reporting, or both.

In some examples, the first frequency is 7 gigahertz. In some examples, the second frequency is 3.5 gigahertz.

In some examples, the inter-band interference is due to second harmonics between the first frequency band and the second frequency band in accordance with the first frequency of the first frequency band being double the second frequency of the second frequency band.

In some examples, the inter-band interference is associated with inter-band carrier aggregation, inter-band dual connectivity, or both.

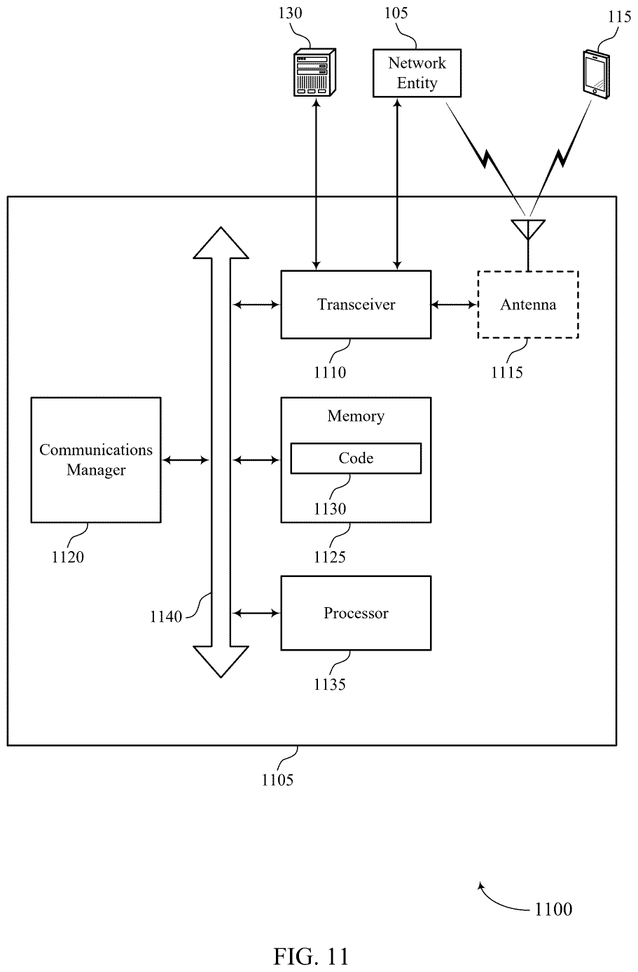

FIG. 11 shows a diagram of a system 1100 including a device 1105 that supports techniques for inter-band interference measurement and reporting in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for inter-band interference measurement and reporting). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for outputting control signaling indicative of one or more resources associated with measurement of inter-band interference between one or more uplink communications received by the network entity and one or more downlink communications transmitted by the network entity, where the inter-band interference is based on a first frequency of a first frequency band associated with the one or more downlink communications being double a second frequency of a second frequency band associated with the one or more uplink communications. The communications manager 1120 is capable of, configured to, or operable to support a means for obtaining a report indicative of the inter-band interference, where the report includes an indication of one or more metrics associated with the inter-band interference.

By including or configuring the communications manager 1120 in accordance with examples as described herein, the device 1105 may support techniques for inter-band interference measurement and reporting, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for inter-band interference measurement and reporting as described herein, or the at least one processor 1135 and the at least one memory 1125 may be otherwise configured to, individually or collectively, perform or support such operations.

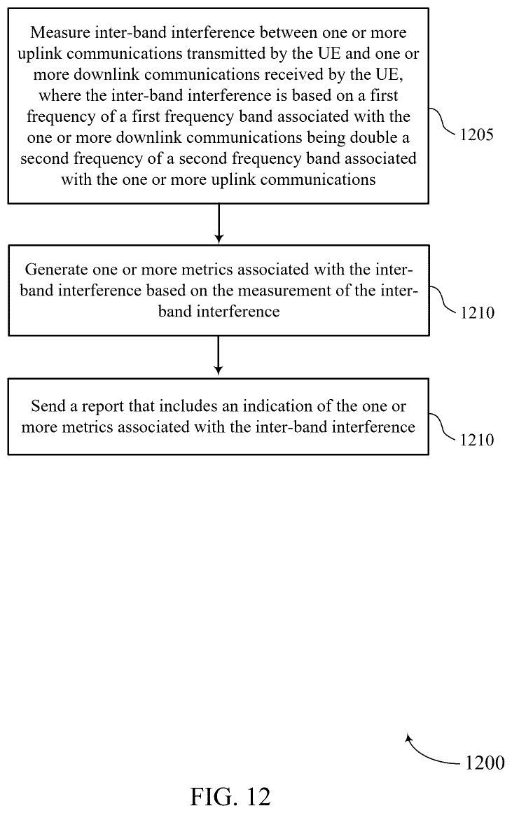

FIG. 12 shows a flowchart illustrating a method 1200 that supports techniques for inter-band interference measurement and reporting in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include measuring inter-band interference between one or more uplink communications transmitted by the UE and one or more downlink communications received by the UE, where the inter-band interference is based on a first frequency of a first frequency band associated with the one or more downlink communications being double a second frequency of a second frequency band associated with the one or more uplink communications. The operations of 1205 may be performed in accordance with examples as disclosed herein. In some examples, aspects of the operations of 1205 may be performed by a measurement component 625 as described with reference to FIG. 6.

At 1210, the method may include generating one or more metrics associated with the inter-band interference based on the measurement of the inter-band interference. The operations of 1205 may be performed in accordance with examples as disclosed herein. In some examples, aspects of the operations of 1205 may be performed by a measurement component 625 as described with reference to FIG. 6.

At 1210, the method may include sending a report that includes an indication of the one or more metrics associated with the inter-band interference. The operations of 1210 may be performed in accordance with examples as disclosed herein. In some examples, aspects of the operations of 1210 may be performed by a reporting component 630 as described with reference to FIG. 6.

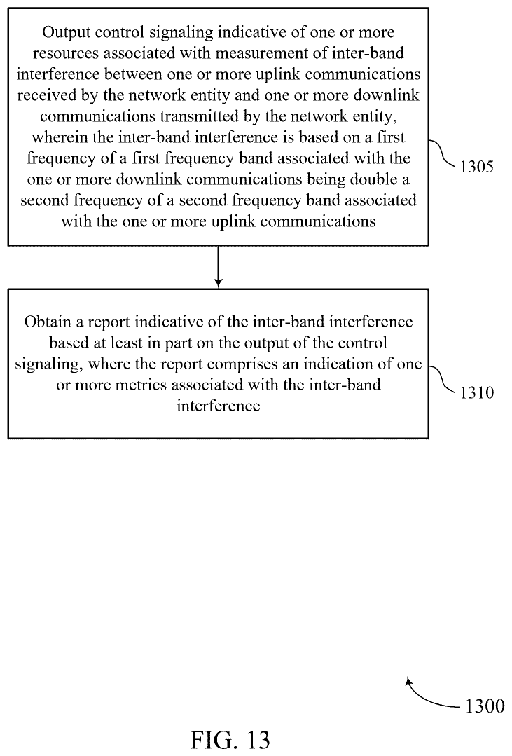

FIG. 13 shows a flowchart illustrating a method 1300 that supports techniques for inter-band interference measurement and reporting in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include outputting control signaling indicative of one or more resources associated with measurement of inter-band interference between one or more uplink communications received by the network entity and one or more downlink communications transmitted by the network entity, where the inter-band interference is based on a first frequency of a first frequency band associated with the one or more downlink communications being double a second frequency of a second frequency band associated with the one or more uplink communications. The operations of 1305 may be performed in accordance with examples as disclosed herein. In some examples, aspects of the operations of 1305 may be performed by a resource allocation component 1025 as described with reference to FIG. 10.

At 1310, the method may include obtaining a report indicative of the inter-band interference based on the output of the control signaling, where the report includes an indication of one or more metrics associated with the inter-band interference. The operations of 1310 may be performed in accordance with examples as disclosed herein. In some examples, aspects of the operations of 1310 may be performed by a feedback component 1030 as described with reference to FIG. 10.

The following provides an overview of aspects of the present disclosure:

Aspect 1: A method for wireless communications at a UE, comprising: measuring inter-band interference between one or more uplink communications transmitted by the UE and one or more downlink communications received by the UE, wherein the inter-band interference is based at least in part on a first frequency of a first frequency band associated with the one or more downlink communications being double a second frequency of a second frequency band associated with the one or more uplink communications; and sending a report that comprises an indication of the one or more metrics associated with the inter-band interference.

Aspect 2: The method of aspect 1, further comprising: receiving control signaling indicative of one or more resources associated with measurement, in the first frequency band associated with the one or more downlink communications, of the inter-band interference, wherein the measurement of the inter-band interference is based at least in part on reception of the control signaling.

Aspect 3: The method of aspect 2, wherein the one or more resources associated with the the measurement of the inter-band interference are periodic, semi-persistent, or aperiodic.

Aspect 4: The method of any of aspects 2 through 3, wherein the control signaling indicates one or more resource identifiers associated with the one or more resources associated with an inter-band interference resource set, an index associated with a first resource of the one or more resources, a quantity of the one or more resources, a symbol associated with the first resource of the one or more resources within a slot, a quantity of symbols associated with the one or more resources within the slot, a periodicity and a slot offset associated with the one or more resources, a subcarrier spacing associated with the one or more resources, QCL information, with qcl-Type set to ‘typeD,’ associated with the one or more resources, or any combination thereof.

Aspect 5: The method of aspect 4, wherein the QCL information comprises a list of TCI states, and the measurement of each of the one or more resources is in accordance with a TCI state from the list of TCI states.

Aspect 6: The method of any of aspects 4 through 5, wherein the measurement of the one or more resources is in accordance with a TCI state associated with one of a last received downlink shared channel prior to the one or more resources and a latest monitored control resource set prior to the one or more resources based at least in part on the QCL information not being configured and based at least in part on unifiedTCI-StateType not being configured.

Aspect 7: The method of any of aspects 4 through 6, wherein the measurement of the one or more resources is in accordance with a TCI state associated with an indicated downlink only TCI state, an indicated joint TCI state, or both, prior to the one or more resources based at least in part on the QCL information not being configured and based at least in part on unifiedTCI-StateType being configured.

Aspect 8: The method of any of aspects 4 through 7, wherein the one or more resources are periodic resources, each resource of the one or more resources is associated with a respective TCI state configured per resource of the one or more resources in accordance with one or more respective parameters, and the measurement of the one or more resources is in accordance with the respective TCI states.

Aspect 9: The method of any of aspects 4 through 8, wherein the control signaling comprises an activation or deactivation MAC-CE message, the activation or deactivation MAC-CE message comprises one or more fields indictive of one or more TCI states associated with the one or more resources, and the measurement of the one or more resources is in accordance with the one or more TCI states.

Aspect 10: The method of any of aspects 2 through 9, wherein the measurement of the inter-band interference is based at least in part on transmission of one or more uplink messages via one or more second resources in the second frequency band associated with the one or more uplink communications, the one or more second resources at least partially overlap the one or more resources, and the one or more uplink messages comprises one or more SRSs, one or more DMRSs, one or more uplink reference signals, or any combination thereof.

Aspect 11: The method of aspect 10, wherein the one or more uplink messages are transmitted in accordance with an uplink transmission power, and the uplink transmission power is a default transmission power, is based at least in part on an indication from a network entity, is based at least in part on a range of uplink transmission powers, or any combination thereof.

Aspect 12: The method of any of aspects 2 through 11, wherein the control signaling comprises a CSI-ResourceConfig IE, and the CSI-ResourceConfig IE is indicative of an interference measurement resource set list comprising the one or more resources.

Aspect 13: The method of any of aspects 2 through 12, wherein the control signaling comprises a CSI-ResourceConfig IE, and the CSI-ResourceConfig IE comprises an indication of an identifier of a resource configuration associated with the one or more resources.

Aspect 14: The method of any of aspects 2 through 13, wherein the control signaling comprises a CSI-IM IE indicative of the one or more resources.

Aspect 15: The method of any of aspects 2 through 14, wherein the one or more resources comprise a set of aperiodic resources, the control signaling is DCI signaling in an aperiodic inter-band interference resource set configuration, and the transmission of the report is in accordance with a slot offset between a first slot associated with the DCI signaling that triggers the set of aperiodic resources and a second slot in which the set of aperiodic resources are measured.

Aspect 16: The method of any of aspects 1 through 15, further comprising: receiving control signaling indicative of configuration information associated with the report, wherein the transmission of the report is based at least in part on reception of the control signaling.

Aspect 17: The method of aspect 16, wherein the control signaling is indicative of a sub-band size, a quantity of sub-bands, or both, and the one or more metrics comprise one or more respective metrics associated with each sub-band among the quantity of sub-bands.

Aspect 18: The method of any of aspects 16 through 17, wherein the control signaling indicates that the report is a wideband report.

Aspect 19: The method of any of aspects 16 through 18, wherein the report is aperiodic, periodic, or semi-persistent.

Aspect 20: The method of any of aspects 16 through 19, wherein the control signaling comprises a CSI-reportConfig IE, the CSI-reportConfig IE comprises a reportQuantity IE, and the reportQuantity IE indicates the report is associated with inter-band interference reporting.

Aspect 21: The method of any of aspects 1 through 20, wherein the transmission of the report is based at least in part on an occurrence of one or more trigger events.

Aspect 22: The method of aspect 21, wherein the one or more trigger events comprise the inter-band interference satisfying a threshold interference, a change in one or more beam pairs, a change in the inter-band interference satisfying a threshold interference change, or any combination thereof.

Aspect 23: The method of any of aspects 21 through 22, further comprising: receiving control signaling indicative of a set of trigger events comprising at least the one or more trigger events, wherein the transmission of the report is based at least in part on reception of the control signaling.

Aspect 24: The method of any of aspects 1 through 23, wherein the transmission of the report is via UCI, a MAC-CE message, or both.

Aspect 25: The method of any of aspects 1 through 24, wherein the measurement of the inter-band interference is via one or more resources in the first frequency band associated with the one or more downlink communications, and the one or more metrics comprise a respective metric associated with each resource of the one or more resources.

Aspect 26: The method of any of aspects 1 through 25, wherein the measurement of the inter-band interference is based on transmission, via one or more resources in the second frequency band, of the one or more uplink communications in accordance with one or more uplink transmission powers, and the one or more metrics include a respective metric associated with each uplink transmission power of the one or more uplink transmission.

Aspect 27: The method of aspect 26, further comprising: transmitting assistance information indicative of the one or more uplink transmission powers, where the measurement of the inter-band interference is via the one or more resources in accordance with one or more uplink transmission powers.

Aspect 28: The method of any of aspects 1 through 27, wherein the measurement of the inter-band interference is via one or more resources in the first frequency band associated with the one or more downlink communications, the one or more metrics comprise a first metric associated with a first sub-configuration of the one or more resources and a second metric associated with a second sub-configuration of the one or more resources.

Aspect 29: The method of any of aspects 1 through 28, wherein the report is associated with a priority value from a set of priority values, and the priority value is zero, one, or a value different than zero or one associated with multiplexing one or more CSI reports.

Aspect 30: The method of any of aspects 1 through 29, wherein the transmission of the report is based at least in part on transmission of one or more uplink messages via one or more uplink resources, and the one or more uplink resources correspond to one or more downlink resources associated with the measurement of the inter-band interference.

Aspect 31: The method of any of aspects 1 through 30, wherein the one or more metrics comprise a first RSSI associated with an absence of the inter-band interference and comprise a second RSSI associated with a presence of the inter-band interference.

Aspect 32: The method of any of aspects 1 through 31, wherein the measurement of the inter-band interference is performed autonomously by the UE, and the transmission of the report is via an uplink grant, a MAC-CE message, one or more periodic uplink resources, or any combination thereof, based at least in part on the measurement of the inter-band interference being performed autonomously by the UE.

Aspect 33: The method of any of aspects 1 through 32, wherein the UE is associated with a plurality of beam pairs, the measurement of the inter-band interference is associated with a subset of the plurality of beam pairs, and the report is indicative of the inter-band interference associated with the plurality of beam pairs based at least in part on inputting the inter-band interference associated with the subset of the plurality of beam pairs into a machine learning model.

Aspect 34: The method of any of aspects 1 through 33, further comprising: receiving control signaling indicative of configuration information associated with the report, wherein the configuration information is indicative of a quantity measurement resources to be reported by the UE, and wherein the transmission of the report is based at least in part on reception of the control signaling.

Aspect 35: The method of any of aspects 1 through 34, wherein the measurement of the inter-band interference is via one or more resources in the first frequency band associated with the one or more downlink communications, each resource of the one or more resources is associated with a beam pair from a plurality of beam pairs, and the one or more metrics comprise a respective metric associated with each beam pair from the plurality of beam pairs.

Aspect 36: The method of aspect 35, wherein the one or more metrics comprise an indication of a first inter-band interference associated with a first beam pair of the plurality of beam pairs and comprise an indication of a respective differential from the first inter-band interference associated with each other beam pair of the plurality of beam pairs, and the first inter-band interference is a highest inter-band interference from among the plurality of beam pairs.

Aspect 37: The method of any of aspects 1 through 36, wherein the measurement of the inter-band interference is via one or more resources in the first frequency band associated with the one or more downlink communications, the one or more metrics comprise an indication of a first inter-band interference associated with a first resource of the one or more resources and comprise an indication of a respective differential from the first inter-band interference associated with each other resource of the one or more resources, and the first inter-band interference is a highest inter-band interference from among the one or more resources.

Aspect 38: The method of any of aspects 1 through 37, wherein transmitting the report comprises: transmitting a NACK message based at least in part on failure to receive the one or more downlink communications, wherein the NACK message comprises the indication of the one or more metrics associated with the inter-band interference based at in part on failure of the UE to receive the one or more downlink communications being based at least in part on the inter-band interference.

Aspect 39: The method of any of aspects 1 through 38, further comprising: receiving control signaling indicative of one or more interference measurement resources associated with measurement, in the first frequency band associated with the one or more downlink communications, of the inter-band interference, wherein the measurement of the inter-band interference is based at least in part on reception of the control signaling.

Aspect 40: The method of any of aspects 1 through 39, wherein the one or more metrics comprise a first CQI associated with an absence of the inter-band interference and comprise a second CQI associated with a presence of the inter-band interference.

Aspect 41: The method of any of aspects 1 through 40, wherein the one or more metrics comprise a first CQI associated with a first sub-configuration of the UE and comprise a second CQI associated with a second sub-configuration of the UE.

Aspect 42: The method of any of aspects 1 through 41, wherein the one or more metrics comprise a first CQI associated with a first set of frequency resources, a first set of sub-bands, a first set of RBs, or any combination thereof, and a second CQI associated with a second set of frequency resources, a second set of sub-bands, a second set of RBs, or any combination thereof.

Aspect 43: The method of any of aspects 1 through 42, wherein the one or more metrics comprise a report quantity indicative of a first CQI associated with an absence of the inter-band interference and a value of the inter-band interference.

Aspect 44: The method of aspect 43, wherein the one or more metrics comprise the report quantity and the value of the inter-band interference comprises a differential value relative to a reference value, and the transmission of the report is based at least in part on the differential value satisfying a threshold differential value.

Aspect 45: The method of any of aspects 1 through 44, further comprising: receiving control signaling scheduling one or more uplink transmissions via one or more uplink resources associated with the measurement of the inter-band interference, and wherein the transmission of the report is based at least in part on the one or more uplink transmissions being scheduled on the one or more uplink resources.

Aspect 46: The method of any of aspects 1 through 45, further comprising: transmitting one or more of a BSR, a power headroom report, a configured payload, or any combination thereof, based at least in part on no uplink data being scheduled via one or more uplink resource associated with the measurement of the inter-band interference.

Aspect 47: The method of any of aspects 1 through 46, wherein one or more CG configuration identifiers, one or more SRS resource identifiers, or both, are associated with the report, and the one or more CG configuration identifiers, the one or more SRS resource identifiers, or both, are associated with one or more uplink resource associated with the measurement of the inter-band interference.

Aspect 48: The method of aspect 47, wherein CG skipping is disabled for one or more CGs associated with the one or more CG configuration identifiers.

Aspect 49: The method of any of aspects 1 through 48, wherein the report comprises an indication of whether the inter-band interference satisfies one or more interference thresholds, an indication to exclude one or more RBs, a range of RBs, or both, associated with the inter-band interference satisfying the one or more interference thresholds, or both.

Aspect 50: The method of aspect 49, wherein the report comprises the indication of whether the inter-band interference satisfies the one or more interference thresholds per RB, per RB level, or both.

Aspect 51: The method of any of aspects 1 through 50, further comprising: transmitting a capability message indicative of whether the UE supports reporting of the inter-band interference, wherein the measurement of the inter-band interference is based at least in part on transmission of the capability message.

Aspect 52: The method of aspect 51, wherein the capability message is indicative of whether the UE supports RSSI-based inter-band interference reporting, CQI-based inter-band interference reporting, or both.

Aspect 53: The method of aspect 52, wherein the capability message is indicative of whether the UE supports each feature of one or more first features associated with RSSI-based inter-band interference reporting, whether the UE supports each feature of one or more second features associated with CQI-based inter-band interference reporting, or both.

Aspect 54: The method of any of aspects 1 through 53, wherein the first frequency is 7 GHz, and the second frequency is 3.5 GHz.

Aspect 55: The method of any of aspects 1 through 54, wherein the inter-band interference is due to second harmonics between the first frequency band and the second frequency band in accordance with the first frequency of the first frequency band being double the second frequency of the second frequency band.

Aspect 56: The method of any of aspects 1 through 55, wherein the inter-band interference is associated with inter-band CA, inter-band DC, or both.

Aspect 57: A method for wireless communications at a network entity, comprising: outputting control signaling indicative of one or more resources associated with measurement of inter-band interference between one or more uplink communications received by the network entity and one or more downlink communications transmitted by the network entity, wherein the inter-band interference is based at least in part on a first frequency of a first frequency band associated with the one or more downlink communications being double a second frequency of a second frequency band associated with the one or more uplink communications; and obtaining a report indicative of the inter-band interference, wherein the report comprises an indication of one or more metrics associated with the inter-band interference.

Aspect 58: The method of aspect 57, further comprising: obtaining, from a second network entity, an indication of one or more second resources associated with measurement of inter-band interference between one or more second uplink communications received by the second network entity and one or more second downlink communications transmitted by the second network entity; and refraining from communicating via the one or more second resources based at least in part on reception of the indication.

Aspect 59: The method of any of aspects 57 through 58, wherein the one or more resources associated with the measurement of the inter-band interference are periodic, semi-persistent, or aperiodic.

Aspect 60: The method of any of aspects 57 through 59, wherein the control signaling indicates one or more resource identifiers associated with the one or more resources associated with an inter-band interference resource set, an index associated with a first resource of the one or more resources, a quantity of the one or more resources, a symbol associated with the first resource of the one or more resources within a slot, a quantity of symbols associated with the one or more resources within the slot, a periodicity and a slot offset associated with the one or more resources, a subcarrier spacing associated with the one or more resources, QCL information, with a QCL type set to ‘typeD,’ associated with the one or more resources, or any combination thereof.

Aspect 61: The method of aspect 60, wherein the QCL information comprises a list of TCI states, and measurement of each of the one or more resources is in accordance with a TCI state from the list of TCI states.

Aspect 62: The method of any of aspects 60 through 61, wherein measurement of the one or more resources is in accordance with a TCI state associated with one of a last received downlink shared channel message prior to the one or more resources and a last monitored control resource set prior to the one or more resources based at least in part on the QCL information not being configured and based at least in part on unifiedTCI-StateType not being configured.

Aspect 63: The method of any of aspects 60 through 62, wherein measurement of the one or more resources is in accordance with a TCI state associated with an indicated downlink only TCI state, an indicated joint TCI state, or both, prior to the one or more resources based at least in part on the QCL information not being configured and based at least in part on unifiedTCI-StateType being configured.

Aspect 64: The method of any of aspects 60 through 63, wherein the one or more resources are periodic resources, each resource of the one or more resources is associated with a respective TCI state configure per resource of the one or more resources in accordance with one or more respective parameters, and measurement of the one or more resources is in accordance with the respective TCI states.

Aspect 65: The method of any of aspects 60 through 64, wherein the control signaling comprises an activation or deactivation MAC-CE message, the activation or deactivation MAC-CE message comprises one or more fields indictive of one or more TCI states associated with the one or more resources, and measurement of the one or more resources is in accordance with the one or more TCI states.

Aspect 66: The method of any of aspects 57 through 65, wherein the obtaining of the report is based at least in part on reception of one or more uplink messages via one or more second resources in the second frequency band associated with the one or more uplink communications, the one or more second resources at least partially overlap the one or more resources, and the one or more uplink messages comprises one or more SRSs, one or more DMRSs, one or more uplink reference signals, or any combination thereof.

Aspect 67: The method of aspect 66, wherein the one or more uplink messages are received in accordance with an uplink transmission power, and the uplink transmission power is a default transmission power, is based at least in part on an indication from the network entity, is based at least in part on a range of uplink transmission powers, or any combination thereof.

Aspect 68: The method of any of aspects 57 through 67, wherein the control signaling comprises a CSI-ResourceConfig IE, and the CSI-ResourceConfig IE is indicative of an interference measurement resource set list comprising the one or more resources.

Aspect 69: The method of any of aspects 57 through 68, wherein the control signaling comprises a CSI-ResourceConfig IE, and the CSI-ResourceConfig IE comprises an indication of an identifier of a resource configuration associated with the one or more resources.

Aspect 70: The method of any of aspects 57 through 69, wherein the control signaling comprises a CSI-IM IE indicative of the one or more resources.

Aspect 71: The method of any of aspects 57 through 70, wherein the one or more resources comprise an set of aperiodic resources, the control signaling is DCI signaling in an aperiodic inter-band interference resource set configuration, and transmission of the report is in accordance with a slot offset between a first slot associated with the DCI signaling that triggers the set of aperiodic resources and a second slot in which the set of aperiodic resources are measured by a UE.

Aspect 72: The method of any of aspects 57 through 71, further comprising: outputting second control signaling indicative of configuration information associated with the report, wherein the obtaining of the report is based at least in part on the output of the second control signaling.

Aspect 73: The method of aspect 72, wherein the second control signaling is indicative of a sub-band size, a quantity of sub-bands, or both, and the one or more metrics comprise one or more respective metrics associated with each sub-band among the quantity of sub-bands.

Aspect 74: The method of any of aspects 72 through 73, wherein the second control signaling indicates that the report is a wideband report.

Aspect 75: The method of any of aspects 72 through 74, wherein the report is aperiodic, periodic, or semi-persistent.

Aspect 76: The method of any of aspects 72 through 75, wherein the second control signaling comprises a CSI-reportConfig IE, the CSI-reportConfig IE comprises a reportQuantity IE, and the reportQuantity IE indicates the report is associated with inter-band interference reporting.

Aspect 77: The method of any of aspects 57 through 76, wherein the obtaining of the report is based at least in part on an occurrence of one or more trigger events.

Aspect 78: The method of aspect 77, wherein the one or more trigger events comprise the inter-band interference satisfying a threshold interference, a change in one or more beam pairs, a change in the inter-band interference satisfying a threshold interference change, or any combination thereof.

Aspect 79: The method of any of aspects 77 through 78, further comprising: outputting second control signaling indicative of a set of trigger events comprising at least the one or more trigger events, wherein the obtaining of the report is based at least in part on reception of the second control signaling.

Aspect 80: The method of any of aspects 57 through 79, wherein reception of the report is via UCI, a MAC-CE message, or both.

Aspect 81: The method of any of aspects 57 through 80, wherein measurement of the inter-band interference is via one or more resources in the first frequency band associated with the one or more downlink communications, and the one or more metrics comprise a respective metric associated with each resource of the one or more resources.

Aspect 82: The method of any of aspects 57 through 81, wherein the one or more metrics comprise a respective metric associated with each resource of the one or more resources associated with one or more uplink transmission powers.

Aspect 83: The method of any of aspects 57 through 82, wherein measurement of the inter-band interference is via one or more resources in the first frequency band associated with the one or more downlink communications, the one or more metrics comprise a first metric associated with a first sub-configuration of the one or more resources and a second metric associated with a second sub-configuration of the one or more resources.

Aspect 84: The method of any of aspects 57 through 83, wherein the report is associated with a priority value from a set of priority values, and the priority value is zero, one, or a value different than zero or one associated with multiplexing one or more CSI reports.

Aspect 85: The method of any of aspects 57 through 84, wherein reception of the report is based at least in part on reception of one or more uplink messages via one or more uplink resources, and the one or more uplink resources correspond to one or more downlink resources associated with measurement of the inter-band interference.

Aspect 86: The method of any of aspects 57 through 85, wherein the one or more metrics comprise a first RSSI associated with an absence of the inter-band interference and comprise a second RSSI associated with a presence of the inter-band interference.

Aspect 87: The method of any of aspects 57 through 86, further comprising: outputting second control signaling indicative of configuration information associated with the report, wherein the configuration information is indicative of a quantity measurement resources to be reported by a UE, and wherein the obtaining of the report is based at least in part on transmission of the second control signaling.

Aspect 88: The method of any of aspects 57 through 87, wherein the network entity is associated with a plurality of beam pairs, and the report is indicative of the inter-band interference associated with the plurality of beam pairs.

Aspect 89: The method of aspect 88, wherein the one or more metrics comprise an indication of a first inter-band interference associated with a first beam pair of the plurality of beam pairs and comprise an indication of a respective differential from the first inter-band interference associated with each other beam pair of the plurality of beam pairs, and the first inter-band interference is a highest inter-band interference from among the plurality of beam pairs.

Aspect 90: The method of any of aspects 57 through 89, wherein measurement of the inter-band interference is via one or more resources in the first frequency band associated with the one or more downlink communications, the one or more metrics comprise an indication of a first inter-band interference associated with a first resource of the one or more resources and comprise an indication of a respective differential from the first inter-band interference associated with each other resource of the one or more resources, and the first inter-band interference is a highest inter-band interference from among the one or more resources.

Aspect 91: The method of any of aspects 57 through 90, further comprising: receiving a NACK message indicating failure of a UE to receive the one or more downlink communications, wherein the NACK message comprises the indication of the one or more metrics associated with the inter-band interference based at in part on failure of the UE to receive the one or more downlink communications being based at least in part on the inter-band interference.

Aspect 92: The method of any of aspects 57 through 91, wherein the one or more metrics comprise a first CQI associated with an absence of the inter-band interference and comprise a second CQI associated with a presence of the inter-band interference.

Aspect 93: The method of any of aspects 57 through 92, wherein the one or more metrics comprise a first CQI associated with a first sub-configuration of a UE and comprise a second CQI associated with a second sub-configuration of the UE.

Aspect 94: The method of any of aspects 57 through 93, wherein the one or more metrics comprise a first CQI associated with a first set of frequency resources, a first set of sub-bands, a first set of RBs, or any combination thereof, and a second CQI associated with a second set of frequency resources, a second set of sub-bands, a second set of RBs, or any combination thereof.

Aspect 95: The method of any of aspects 57 through 94, wherein the one or more metrics comprise a report quantity indicative of a first CQI associated with an absence of the inter-band interference and a value of the inter-band interference.

Aspect 96: The method of aspect 95, wherein the one or more metrics comprise the report quantity and the value of the inter-band interference comprises a differential value relative to a reference value, and the obtaining of the report is based at least in part on the differential value satisfying a threshold differential value.

Aspect 97: The method of any of aspects 57 through 96, further comprising: outputting second control signaling scheduling one or more uplink transmissions via one or more uplink resources associated with measurement of the inter-band interference, and wherein the obtaining of the report is based at least in part on the one or more uplink transmissions being scheduled on the one or more uplink resources.

Aspect 98: The method of any of aspects 57 through 97, further comprising: obtaining one or more of a BSR, a power headroom report, a configured payload, or any combination thereof, based at least in part on no uplink data being scheduled via one or more uplink resource associated with measurement of the inter-band interference.

Aspect 99: The method of any of aspects 57 through 98, wherein one or more CG configuration identifiers, one or more SRS resource identifiers, or both, are associated with the report, and the one or more CG configuration identifiers, the one or more SRS resource identifiers, or both, are associated with one or more uplink resource associated with measurement of the inter-band interference.

Aspect 100: The method of aspect 99, wherein CG skipping is disabled for one or more CGs associated with the one or more CG configuration identifiers.

Aspect 101: The method of any of aspects 57 through 100, wherein the report comprises an indication of whether the inter-band interference satisfies one or more interference thresholds, an indication to exclude one or more RBs, a range of RBs, or both, associated with the inter-band interference satisfying the one or more interference thresholds, or both.

Aspect 102: The method of aspect 101, wherein the report comprises the indication of whether the inter-band interference satisfies the one or more interference thresholds per RB, per RB level, or both.

Aspect 103: The method of any of aspects 57 through 102, further comprising: obtaining a capability message indicative of whether a UE supports reporting of the inter-band interference, wherein the obtaining of the report is based at least in part on transmission of the capability message.

Aspect 104: The method of aspect 103, wherein the capability message is indicative of whether the UE supports RSSI-based inter-band interference reporting, CQI-based inter-band interference reporting, or both.

Aspect 105: The method of aspect 104, wherein the capability message is indicative of whether the UE supports each feature of one or more first features associated with RSSI-based inter-band interference reporting, whether the UE supports each feature of one or more second features associated with CQI-based inter-band interference reporting, or both.

Aspect 106: The method of any of aspects 57 through 105, wherein the first frequency is 7 GHz, and the second frequency is 3.5 GHz.

Aspect 107: The method of any of aspects 57 through 106, wherein the inter-band interference is due to second harmonics between the first frequency band and the second frequency band in accordance with the first frequency of the first frequency band being double the second frequency of the second frequency band.

Aspect 108: The method of any of aspects 57 through 107, wherein the inter-band interference is associated with inter-band CA, inter-band DC, or both.

Aspect 109: A UE for wireless communications, comprising one or more memories storing processor-executable code, and one or more processors coupled with the one or more memories and individually or collectively operable to execute the code to cause the UE to perform a method of any of aspects 1 through 56.

Aspect 110: A UE for wireless communications, comprising at least one means for performing a method of any of aspects 1 through 56.

Aspect 111: A non-transitory computer-readable medium storing code for wireless communications, the code comprising instructions executable by one or more processors to perform a method of any of aspects 1 through 56.

Aspect 112: A network entity for wireless communications, comprising one or more memories storing processor-executable code, and one or more processors coupled with the one or more memories and individually or collectively operable to execute the code to cause the network entity to perform a method of any of aspects 57 through 108.

Aspect 113: A network entity for wireless communications, comprising at least one means for performing a method of any of aspects 57 through 108.

Aspect 114: A non-transitory computer-readable medium storing code for wireless communications, the code comprising instructions executable by one or more processors to perform a method of any of aspects 57 through 108.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, the phrase “additionally, or alternatively” may be understood to mean “and/or,” such that the terms “additionally, or alternatively” and “and/or” may be interchangeable.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
measure inter-band interference between one or more uplink communications transmitted by the UE and one or more downlink communications received by the UE, wherein the inter-band interference is based at least in part on a first frequency of a first frequency band associated with the one or more downlink communications being double a second frequency of a second frequency band associated with the one or more uplink communications;
generate one or more metrics associated with the inter-band interference based at least in part on the measurement of the inter-band interference; and
send a report that comprises an indication of the one or more metrics associated with the inter-band interference.

2. The UE of claim 1, wherein the one or more processors are individually or collectively further operable to execute the code to cause the UE to:
receive control signaling indicative of one or more resources to be used for the measurement, in the first frequency band associated with the one or more downlink communications, of the inter-band interference.

3. The UE of claim 2, wherein the control signaling indicates one or more resource identifiers associated with the one or more resources associated with an inter-band interference resource set, an index associated with a first resource of the one or more resources, a quantity of the one or more resources, a symbol associated with the first resource of the one or more resources within a slot, a quantity of symbols associated with the one or more resources within the slot, a periodicity and a slot offset associated with the one or more resources, a subcarrier spacing associated with the one or more resources, quasi-co-location information, with qcl-Type set to ‘typeD,’ associated with the one or more resources, or any combination thereof.

4. The UE of claim 3, wherein the quasi-co-location information comprises a list of transmission configuration indicator states, and wherein measurement of each of the one or more resources is in accordance with a transmission configuration indicator state from the list of transmission configuration indicator states.

5. The UE of claim 3, wherein the control signaling comprises an activation or deactivation medium access control-control element message, wherein the activation or deactivation medium access control-control element message comprises one or more fields indictive of one or more transmission configuration indicator states associated with the one or more resources, and wherein the measurement of the one or more resources is in accordance with the one or more transmission configuration indicator states.

6. The UE of claim 3, wherein the measurement of the inter-band interference is based at least in part on transmission of one or more uplink messages via one or more second resources in the second frequency band associated with the one or more uplink communications, wherein the one or more second resources at least partially overlap the one or more resources, and wherein the one or more uplink messages comprises one or more sounding reference signals, one or more demodulation reference signals, one or more uplink reference signals, or any combination thereof.

7. The UE of claim 2, wherein the one or more resources comprise a set of aperiodic resources, wherein the control signaling is downlink control information signaling in an aperiodic inter-band interference resource set configuration, and wherein the transmission of the report is in accordance with a slot offset between a first slot associated with the downlink control information signaling that triggers the set of aperiodic resources and a second slot in which the set of aperiodic resources are measured.

8. The UE of claim 1, wherein the one or more processors are individually or collectively further operable to execute the code to cause the UE to:
receive control signaling indicative of configuration information associated with the report, wherein the transmission of the report is based at least in part on reception of the control signaling.

9. The UE of claim 8, wherein the control signaling is indicative of a sub-band size, a quantity of sub-bands, or both, and wherein the one or more metrics comprise one or more respective metrics associated with each sub-band among the quantity of sub-bands.

10. The UE of claim 1, wherein the transmission of the report is based at least in part on an occurrence of one or more trigger events, and wherein the one or more trigger events comprise the inter-band interference satisfying a threshold interference, a change in one or more beam pairs, a change in the inter-band interference satisfying a threshold interference change, or any combination thereof.

11. The UE of claim 1, wherein the measurement of the inter-band interference is based on transmission, via one or more resources in the second frequency band, of the one or more uplink communications in accordance with one or more uplink transmission powers, and wherein the one or more metrics comprise a respective metric associated with each uplink transmission power of the one or more uplink transmission powers.

12. The UE of claim 1, wherein the measurement of the inter-band interference is via one or more resources in the first frequency band associated with the one or more downlink communications, and wherein the one or more metrics comprise a first metric associated with a first sub-configuration of the one or more resources and a second metric associated with a second sub-configuration of the one or more resources.

13. The UE of claim 1, wherein the transmission of the report is based at least in part on transmission of one or more uplink messages via one or more uplink resources, and wherein the one or more uplink resources correspond to one or more downlink resources associated with the measurement of the inter-band interference.

14. The UE of claim 1, wherein the one or more metrics comprise a first received signal strength indicator associated with an absence of inter-band interference and comprise a second received signal strength indicator associated with a presence of the inter-band interference.

15. The UE of claim 1, wherein the measurement of the inter-band interference is performed autonomously by the UE, and wherein the transmission of the report is via an uplink grant, a medium access control-control element (MAC-CE) message, one or more periodic uplink resources, or any combination thereof, based at least in part on the measurement of the inter-band interference being performed autonomously by the UE.

16. The UE of claim 1, wherein the UE is associated with a plurality of beam pairs, wherein the measurement of the inter-band interference is associated with a subset of the plurality of beam pairs, and wherein the report is indicative of the inter-band interference associated with the plurality of beam pairs based at least in part on inputting the inter-band interference associated with the subset of the plurality of beam pairs into a machine learning model.

17. The UE of claim 1, wherein the measurement of the inter-band interference is via one or more resources in the first frequency band associated with the one or more downlink communications, wherein each resource of the one or more resources is associated with a beam pair from a plurality of beam pairs, and wherein the one or more metrics comprise a respective metric associated with each beam pair from the plurality of beam pairs.

18. The UE of claim 17, wherein the one or more metrics comprise an indication of a first inter-band interference associated with a first beam pair of the plurality of beam pairs and comprise an indication of a respective differential from the first inter-band interference associated with each other beam pair of the plurality of beam pairs, and wherein the first inter-band interference is a highest inter-band interference from among the plurality of beam pairs.

19. The UE of claim 1, wherein the measurement of the inter-band interference is via one or more resources in the first frequency band associated with the one or more downlink communications, wherein the one or more metrics comprise an indication of a first inter-band interference associated with a first resource of the one or more resources and comprise an indication of a respective differential from the first inter-band interference associated with each other resource of the one or more resources, and wherein the first inter-band interference is a highest inter-band interference from among the one or more resources.

20. The UE of claim 1, wherein, to transmit the report, the one or more processors are individually or collectively operable to execute the code to cause the UE to:
transmit a negative acknowledgment (NACK) message based at least in part on failure to receive the one or more downlink communications, wherein the NACK message comprises the indication of the one or more metrics associated with the inter-band interference based at in part on failure of the UE to receive the one or more downlink communications being based at least in part on the inter-band interference.

21. The UE of claim 1, wherein the one or more metrics comprise a first channel quality indicator associated with an absence of the inter-band interference and comprise a second channel quality indicator associated with a presence of the inter-band interference.

22. The UE of claim 1, wherein the one or more metrics comprise a first channel quality indicator associated with a first sub-configuration of the UE and comprise a second channel quality indicator associated with a second sub-configuration of the UE.

23. The UE of claim 1, wherein the one or more metrics comprise a first channel quality indicator associated with a first set of frequency resources, a first set of sub-bands, a first set of resource blocks, or any combination thereof, and wherein a second channel quality indicator associated with a second set of frequency resources, a second set of sub-bands, a second set of resource blocks, or any combination thereof.

24. The UE of claim 1, wherein the one or more metrics comprise a report quantity indicative of a first channel quality indicator associated with no inter-band interference and a value of the inter-band interference.

25. The UE of claim 1, wherein the one or more processors are individually or collectively further operable to execute the code to cause the UE to:
receive control signaling scheduling one or more uplink transmissions via one or more uplink resources associated with the measurement of the inter-band interference, and wherein the transmission of the report is based at least in part on the one or more uplink transmissions being scheduled on the one or more uplink resources.

26. The UE of claim 1, wherein the one or more processors are individually or collectively further operable to execute the code to cause the UE to:
transmit one or more of a buffer status report, a power headroom report, a configured payload, or any combination thereof, based at least in part on no uplink data being scheduled via one or more uplink resource associated with the measurement of the inter-band interference.

27. A network entity, comprising:
one or more memories storing processor-executable code; and
one or more processors coupled with the one or more memories and individually or collectively operable to execute the code to cause the network entity to:
output control signaling indicative of one or more resources associated with measurement of inter-band interference between one or more uplink communications received by the network entity and one or more downlink communications transmitted by the network entity, wherein the inter-band interference is based at least in part on a first frequency of a first frequency band associated with the one or more downlink communications being double a second frequency of a second frequency band associated with the one or more uplink communications; and
obtain a report indicative of the inter-band interference based at least in part on the output of the control signaling, wherein the report comprises an indication of one or more metrics associated with the inter-band interference.

28. The network entity of claim 27, wherein the one or more processors are individually or collectively further operable to execute the code to cause the network entity to:
obtain, from a second network entity, an indication of one or more second resources associated with measurement of inter-band interference between one or more second uplink communications received by the second network entity and one or more second downlink communications transmitted by the second network entity; and
refrain from communicating via the one or more second resources based at least in part on reception of the indication.

29. A method for wireless communications at a user equipment (UE), comprising:
measuring inter-band interference between one or more uplink communications transmitted by the UE and one or more downlink communications received by the UE, wherein the inter-band interference is based at least in part on a first frequency of a first frequency band associated with the one or more downlink communications being double a second frequency of a second frequency band associated with the one or more uplink communications;
generating one or more metrics associated with the inter-band interference based at least in part on the measurement of the inter-band interference; and
sending a report that comprises an indication of the one or more metrics associated with the inter-band interference.

30. A method for wireless communications at a network entity, comprising:
outputting control signaling indicative of one or more resources associated with measurement of inter-band interference between one or more uplink communications received by the network entity and one or more downlink communications transmitted by the network entity, wherein the inter-band interference is based at least in part on a first frequency of a first frequency band associated with the one or more downlink communications being double a second frequency of a second frequency band associated with the one or more uplink communications; and
obtaining a report indicative of the inter-band interference based at least in part on the output of the control signaling, wherein the report comprises an indication of one or more metrics associated with the inter-band interference.
